(19) United States
(12) Patent Application Publication
(10) Pub. No.: US 2020/0294124 A1
(43) Pub. Date: Sep. 17, 2020

(54) BLOCKCHAIN-BASED METHOD, APPARATUS, AND DEVICE

(71) Applicant: ALIBABA GROUP HOLDING LIMITED, Grand Cayman (KY)

(72) Inventors: Boyan JIA, HANGZHOU (CN); Yanpeng LI, HANGZHOU (CN)

(21) Appl. No.: 16/888,305

(22) Filed: May 29, 2020

Related U.S. Application Data
(63) Continuation of application No. PCT/CN2020/071973, filed on Jan. 14, 2020.

(30) Foreign Application Priority Data
Jul. 30, 2019 (CN) 201910696461.X

(51) Int. Cl. G06Q 40/02; G06F 16/23; G06Q 10/10; G06Q 30/00; G06Q 20/22

(52) U.S. Cl. CPC G06Q 40/02; G06F 16/2379; H04L 63/10; G06Q 30/0185; G06Q 20/223; G06Q 10/10

(57) ABSTRACT

Methods, systems, apparatus, and computer programs encoded on computer storage media, for a blockchain are provided. One method includes: receiving a resource collection request; generating a resource collection record and an identifier of the resource collection record based on the resource collection request; recording the identifier of the resource collection record and an identifier of a first user corresponding to the resource collection record; releasing information associated with the resource collection request by invoking a first blockchain contract; receiving a resource transfer request comprising the identifier of the first user and a resource transfer quantity; generating a resource transfer record according to the resource transfer request, the resource transfer record comprising the resource transfer quantity, the identifier of the first user, the identifier of the resource collection record; and recording the resource transfer record.

### CROSS-REFERENCE TO RELATED APPLICATION

This application is a continuation application of International Patent Application No. PCT/CN2020/071973, filed with the China National Intellectual Property Administration (CNIPA) on Jan. 14, 2020, which is based on and claims priority to and benefit of Chinese Patent Application No. 201910696461.X, filed with the CNIPA on Jul. 30, 2019. The entire contents of all of the above-identified applications are incorporated herein by reference.

### TECHNICAL FIELD

The application relates to the field of blockchain technologies, and in particular, to a blockchain-based transaction method, apparatus, and device, a blockchain-based transaction supervision method, apparatus, and device, and a computer readable storage medium.

### BACKGROUND

Person-to-person lending or peer-to-peer lending (P2P lending), also referred to as online point-to-point lending, is a non-governmental micro-lending mode of aggregating small amounts of money and lending the money to people in need, which is an Internet finance (ITFIN) product. In the current P2P lending mode, a centralized P2P credit institution stores lending data, such as loan contracts. However, information published by the P2P credit institution is not transparent. Therefore, problems such as loan contract loss, loan contract tampering, or the P2P credit institution evading responsibility or escaping may occur. In addition, it is difficult for investors to testify and defend their rights.

### SUMMARY

One or more embodiments of the specification provide a blockchain-based transaction method, apparatus, and device, and a blockchain-based transaction supervision method, apparatus, and device. A transaction is performed in a reliable environment of a blockchain, so that a transaction process is public and transparent and is available to a plurality of parties. Further, it is ensured that chained data is tamperproof and publicly available, problems such as data loss and data fraud are effectively avoided, and problems such as difficulties in testifying and defending rights of a resource transfer user are resolved. In addition, whether a resource transaction institution has a transaction risk can be supervised based on transaction record information stored in the blockchain, to effectively reduce the occurrence that the resource transaction institution evades the responsibility, escapes, or the like.

To resolve the foregoing technical problems, the one or more embodiments of the specification are implemented as follows.

The one or more embodiments of the specification provide a blockchain-based transaction method, including: receiving, by a first blockchain node, a resource collection request sent by a terminal device of a resource collection user, wherein the resource collection request includes resource collection information; releasing, by the first blockchain node, the resource collection information to a blockchain by invoking or otherwise using a first smart contract or blockchain contract, for a terminal device of a resource transfer user to obtain the resource collection information from the blockchain; receiving, by the first blockchain node, a resource transfer request sent by the terminal device of the resource transfer user, wherein the resource transfer request includes: user information of a target resource collection user that is selected based on the resource collection information to perform resource transfer to, and resource transfer information of the resource transfer performed to the target resource collection user; and generating, by the first blockchain node, resource transfer record information according to the resource transfer request, and writing the resource transfer record information to the blockchain.

The one or more embodiments of the specification provide a blockchain-based transaction supervision method, including: obtaining, by a second blockchain node, transaction record information of a resource transaction institution from a blockchain, wherein the transaction record information includes at least one piece of information among resource collection record information, resource status record information, resource transfer record information, resource extraction record information, first registration record information, bulletin release record information, and bulletin revocation record information; determining, by the second blockchain node based on the transaction record information by invoking or otherwise using a second smart contract or blockchain contract, whether the resource transaction institution has a transaction risk; and sending, by the second blockchain node, alert information to a tracing institution using the second blockchain contract if the resource transaction institution has a transaction risk, for the tracing institution to perform tracing processing on the resource transaction institution.

The one or more embodiments of the specification provide a blockchain-based transaction apparatus, including: a receiving module, which is configured to receive a resource collection request sent by a terminal device of a resource collection user, wherein the resource collection request includes resource collection information; a release module, which is configured to release the resource collection information to a blockchain by invoking or otherwise using a first blockchain contract, for a terminal device of a resource transfer user to obtain the resource collection information from the blockchain, wherein the receiving module is further configured to receive a resource transfer request sent by the terminal device of the resource transfer user, wherein the resource transfer request includes: user information of a target resource collection user that is selected based on the resource collection information to perform resource transfer to, and resource transfer information of the resource transfer performed to the target resource collection user; a generation module, which is configured to generate resource transfer record information according to the resource transfer request; and a write module, which is configured to write the resource transfer record information to the blockchain.

The one or more embodiments of the specification provide a blockchain-based transaction supervision apparatus, including: an obtaining module, which is configured to obtain transaction record information of a resource transaction institution from a blockchain, wherein the transaction record information includes at least one piece of information among resource collection record information, resource status record information, resource transfer record information, resource extraction record information, first registration record information, bulletin release record information, and bulletin revocation record information; a determining module, which is configured to determine, based on the transaction record information by invoking or otherwise using a second blockchain contract, whether the resource transaction institution has a transaction risk; and a sending module, which is configured to send alert information to a tracing institution using the second blockchain contract when the determining module determines that the resource transaction institution has a transaction risk, for the tracing institution to perform tracing processing on the resource transaction institution.

The one or more embodiments of the specification provide a blockchain-based transaction device, including a processor and a memory configured to store computer executable instructions, wherein the computer executable instructions, when executed, cause the processor to implement steps of the blockchain-based transaction method.

The one or more embodiments of the specification provide a blockchain-based transaction supervision device, including a processor and a memory configured to store computer executable instructions, wherein the computer executable instructions, when executed, cause the processor to implement steps of the blockchain-based transaction supervision method.

The one or more embodiments of the specification provide a storage medium, configured to store computer executable instructions, wherein the computer executable instructions, when executed, implement steps of the blockchain-based transaction method or implement steps of the blockchain-based transaction supervision method.

In an aspect, a blockchain-based method comprises: receiving, by a blockchain node associated with a blockchain from a terminal device of a first user, a resource collection request; generating, by the blockchain node, a resource collection record and an identifier of the resource collection record based on the resource collection request; recording, by the blockchain node to the blockchain, the identifier of the resource collection record and an identifier of the first user in correspondence with the resource collection record; releasing, by the blockchain node to the blockchain, information associated with the resource collection request by invoking a first blockchain contract; receiving, by the blockchain node from a terminal device of a second user, a resource transfer request comprising the identifier of the first user and a resource transfer quantity, the resource transfer request being generated in response to the terminal device of the second user obtaining the information associated with the resource collection request from the blockchain; generating, by the blockchain node, a resource transfer record according to the resource transfer request, the resource transfer record comprising the resource transfer quantity, the identifier of the first user, the identifier of the resource collection record; and recording, by the blockchain node to the blockchain, the resource transfer record.

In an embodiment, the resource collection request comprises a total resource quantity to be collected, and the generating a resource transfer record comprises determining that a sum of a quantity of currently collected resources and the resource transfer quantity is not greater than the total resource quantity to be collected.

In an embodiment, the resource collection request comprises a resource grant time. The method further comprises: providing, by the blockchain node, the resource transfer quantity of a resource to the first user when the resource grant time arrives; generating, by the blockchain node, a resource grant record comprising the identifier of the resource collection record information; and recording, by the blockchain node to the blockchain, the resource grant record.

In an embodiment, the method further comprises generating, by the blockchain node, a resource status record associated with resources to be collected in response to the resource collection request, wherein the resource status record comprises the identifier of the resource collection record.

In an embodiment, the method further comprises: receiving, by the blockchain node from the terminal device of the second user, a resource extraction request; extracting, by the blockchain node, a resource of the second user according to the resource extraction request; generating, by the blockchain node, a resource extraction record, wherein the resource extraction record comprises a resource extraction time, an identifier of the second user, and an institution identifier of a resource transaction institution; and recording, by the blockchain node to the blockchain, the resource extraction record.

In an embodiment, the method further comprises: obtaining, by the blockchain node, bulletin information of an operating status of a resource transaction institution released by a user on a website or an application (APP) of the resource transaction institution on a terminal device of the user; generating, by the blockchain node, a bulletin release record according to the bulletin information, wherein the bulletin release record comprises key information of the bulletin information and an identifier of the resource transaction institution; and recording, by the blockchain node to the blockchain, the bulletin release record.

In an embodiment, the method further comprises: obtaining, by the blockchain node, a revocation of the bulletin information by the user on a website or an application (APP) of the resource transaction institution on a terminal device of the user; generating, by the blockchain node, a bulletin revocation record according to the revoked bulletin information, wherein the bulletin revocation record comprises a revocation time at which the bulletin information is revoked and the institution identifier of the resource transaction institution; and recording, by the blockchain node to the blockchain, the bulletin revocation record.

In an embodiment, the method further comprises, before receiving the resource transfer request: receiving, by the blockchain node from the terminal device of the second user, a registration request; determining, by the blockchain node, whether information in the registration request is valid; determining, by the blockchain node in response to determining that the information in the registration request is valid, an identifier of the second user; generating, by the blockchain node, a registration record according to the information in the registration request, the identifier of the second user, an institution identifier of a resource transaction institution; and recording, by the blockchain node to the blockchain, the registration record information.

In another aspect, a blockchain-based system comprises a processor and a non-transitory computer-readable storage medium storing instructions executable by the processor to cause the system to perform operations. The operations comprise: receiving, from a terminal device of a first user, a resource collection request; generating, a resource collection record and an identifier of the resource collection record based on the resource collection request; recording, to the blockchain, the identifier of the resource collection record and an identifier of the first user in correspondence with the resource collection record; releasing, to the blockchain, information associated with the resource collection request by invoking a first blockchain contract; receiving, from a terminal device of a second user, a resource transfer request comprising the identifier of the first user and a resource transfer quantity, the resource transfer request being generated in response to the terminal device of the second user obtaining the information associated with the resource collection request from the blockchain; generating, a resource transfer record according to the resource transfer request, the resource transfer record comprising the resource transfer quantity, the identifier of the first user, the identifier of the resource collection record; and recording, to the blockchain, the resource transfer record.

In yet another aspect, a non-transitory computer-readable storage medium for a blockchain is configured with instructions executable by one or more processors to cause the one or more processors to operations. The operations comprise: receiving, from a terminal device of a first user, a resource collection request; generating, a resource collection record and an identifier of the resource collection record based on the resource collection request; recording, to the blockchain, the identifier of the resource collection record and an identifier of the first user in correspondence with the resource collection record; releasing, to the blockchain, information associated with the resource collection request by invoking a first blockchain contract; receiving, from a terminal device of a second user, a resource transfer request comprising the identifier of the first user and a resource transfer quantity, the resource transfer request being generated in response to the terminal device of the second user obtaining the information associated with the resource collection request from the blockchain; generating, a resource transfer record according to the resource transfer request, the resource transfer record comprising the resource transfer quantity, the identifier of the first user, the identifier of the resource collection record; and recording, to the blockchain, the resource transfer record.

According to the blockchain-based transaction method, apparatus, and device, and the blockchain-based transaction supervision method, apparatus, and device in the one or more embodiments of the specification, a transaction is performed in a reliable environment of a blockchain, so that a transaction process is public and transparent and is available to a plurality of parties, which achieves a deterrent effect to illegal behaviors. Further, transaction record information such as resource transfer record information is stored in the blockchain, so that it is ensured that chained data is tamperproof and publicly available, problems such as data loss and data fraud are effectively avoided, and problems such as difficulties in testifying and defending rights of a resource transfer user are resolved. In addition, whether a resource transaction institution has a transaction risk can be supervised based on transaction record information stored in the blockchain, to effectively reduce the occurrence that the resource transaction institution evades the responsibility, escapes, or the like.

### BRIEF DESCRIPTION OF THE DRAWINGS

To describe the technical solutions in one or more embodiments of the specification or in the existing technologies more clearly, the following briefly introduces the accompanying drawings required for describing the embodiments or the existing technologies. The accompanying drawings in the following description show merely some embodiments of the specification, and a person of ordinary skill in the art may still derive other drawings from these accompanying drawings without creative efforts.

FIG. 1 is a schematic diagram of a scenario of a blockchain-based transaction system, according to one or more embodiments of the specification.

FIG. 2 is a schematic diagram of a data flow of a blockchain-based transaction method, according to one or more embodiments of the specification.

FIG. 3 is a first flowchart of a blockchain-based transaction method, according to one or more embodiments of the specification.

FIG. 4 is a second flowchart of a blockchain-based transaction method, according to one or more embodiments of the specification.

FIG. 5(A) and FIG. 5(B) constitute a third flowchart of a blockchain-based transaction method, according to one or more embodiments of the specification.

FIG. 6 is a schematic diagram of a scenario of a blockchain-based transaction supervision system, according to one or more embodiments of the specification.

FIG. 7 is a flowchart of a blockchain-based transaction supervision method, according to one or more embodiments of the specification.

FIG. 8 is a schematic diagram of a blockchain-based transaction apparatus, according to one or more embodiments of the specification.

FIG. 9 is a schematic diagram of a blockchain-based transaction supervision apparatus, according to one or more embodiments of the specification.

FIG. 10 is a schematic structural diagram of a blockchain-based transaction device, according to one or more embodiments of the specification.

FIG. 11 is a schematic structural diagram of a blockchain-based transaction supervision device, according to one or more embodiments of the specification.

### DETAILED DESCRIPTION OF EMBODIMENTS

For a better understanding of the technical solutions in one or more embodiments of the specification by those skilled in the art, the technical solutions in the one or more embodiments of the specification will be clearly and completely described below with reference to the accompanying drawings in the one or more embodiments of the specification. The described embodiments are some rather than all of the embodiments of the specification. All other embodiments obtained by a person of ordinary skill in the art based on one or more embodiments of the specification without creative efforts shall fall within the protection scope of the specification.

One or more embodiments of the specification provide a blockchain-based transaction method, apparatus, and device, and a blockchain-based transaction supervision method, apparatus, and device. A transaction is performed in a reliable environment of a blockchain, so that a transaction process is public and transparent and is available to a plurality of parties, which achieves a deterrent effect to illegal behaviors. Further, transaction record information such as resource transfer record information is stored in the blockchain, so that it is ensured that chained data is tamperproof and publicly available, problems such as data loss and data fraud are effectively avoided, and problems such as difficulties in testifying and defending rights of a resource transfer user are resolved. In addition, whether a resource transaction institution has a transaction risk can be supervised based on transaction record information stored in the blockchain, to effectively reduce the occurrence that the resource transaction institution evades the responsibility, escapes, or the like. The blockchain-based transaction method, apparatus, and device, and the blockchain-based transaction supervision method, apparatus, and device provided in the embodiments of the specification not only may be implemented on money allocation, but also may be implemented on allocation of other resources, for example, allocation of data.

FIG. 1 is a schematic diagram of an application scenario of a blockchain-based transaction system, according to one or more embodiments of the specification. As shown in FIG. 1, the system includes a first blockchain node, a terminal device of a resource collection user, and a terminal device of a resource transfer user. The first blockchain node, the terminal device of the resource collection user, and the terminal device of the resource transfer user all access a blockchain, for example, a P2P consortium blockchain. The terminal device of the resource collection user and the terminal device of the resource transfer user may be mobile phones, tablet computers, desktop computers, portable laptop computers, and the like. The terminal device of the resource collection user and the terminal device of the resource transfer user both communicate to the first blockchain node through a wireless network.

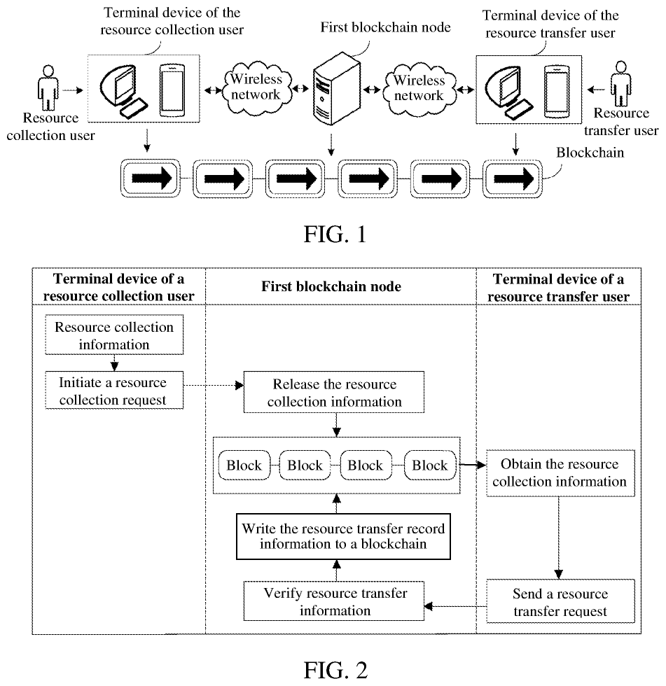

Referring to FIG. 2, the terminal device of a first user, such as the resource collection user, receives resource collection information sent by the resource collection user, generates a resource collection request according to the resource collection information, and sends the resource collection request to the first blockchain node. The first blockchain node receives the resource collection request sent by the terminal device of the resource collection user, and releases the resource collection information included in the resource collection request to the blockchain by invoking or otherwise using a first blockchain contract, for the terminal device of the resource transfer user to obtain the resource collection information from the blockchain. A second user, such as the resource transfer user, operates the terminal device of the resource transfer user, browses resource collection information that is released in the blockchain by the first blockchain node, selects a target resource collection user for resource transfer, and submits resource transfer information. The terminal device of the resource transfer user sends a resource transfer request to the first blockchain node according to user information of the target resource collection user selected by the resource transfer user and the resource transfer information submitted by the resource transfer user. The first blockchain node receives the resource transfer request sent by the terminal device of the resource transfer user, verifies the resource transfer information, generates resource transfer record information according to the resource transfer request when the verification succeeds, and writes the resource transfer record information to the blockchain. The resource collection user and the resource transfer user may be individuals, or may be users specified by enterprises. The resource collection information includes information such as a total resource quantity of to-be-collected resources, a resource collection reason, a resource grant time, or a resource return time. The resource transfer information includes information such as a resource transfer quantity. Further, the resource grant time is a time at which a resource transaction institution grants collected resources to the resource collection user as the resource collection user requests, and the resource return time may be installment return times or a one-time return time for the resources.

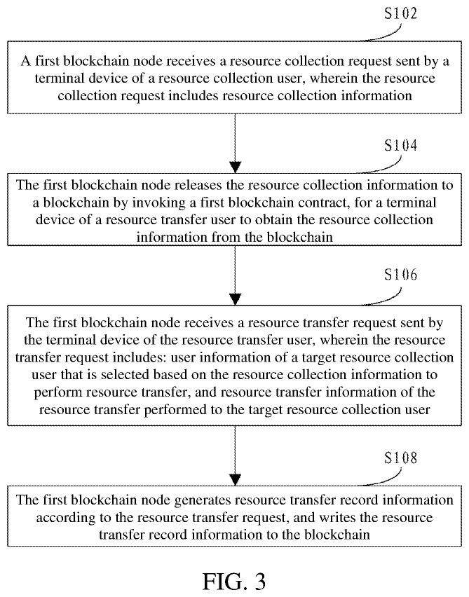

FIG. 3 is a flowchart of a blockchain-based transaction method, according to one or more embodiments of the specification. The method in FIG. 3 can be performed by the first blockchain node in FIG. 1. As shown in FIG. 3, the method includes followings.

Step S102, the first blockchain node receives a resource collection request sent by a terminal device of a resource collection user, wherein the resource collection request includes resource collection information.

Step S104, the first blockchain node releases the resource collection information to a blockchain by invoking or otherwise using a first blockchain contract, for a terminal device of a resource transfer user to obtain the resource collection information from the blockchain.

Step S106, the first blockchain node receives a resource transfer request sent by the terminal device of the resource transfer user, wherein the resource transfer request includes user information of a target resource collection user that is selected based on the resource collection information to perform resource transfer to, and resource transfer information of the resource transfer performed to the target resource collection user.

Step S108, the first blockchain node generates resource transfer record information according to the resource transfer request, and writes the resource transfer record information to the blockchain.

In the one or more embodiments of the specification, a transaction is performed in a reliable environment of a blockchain, so that a transaction process is public and transparent and is available to a plurality of parties, which achieves a deterrent effect to illegal behaviors. In addition, transaction transfer record information is written to the blockchain, so that it is ensured that chained data is tamperproof and publicly available, problems such as data loss and data fraud are effectively avoided, and problems such as difficulties in testifying and defending rights of a resource transfer user are resolved.

To effectively manage resource transfer users, in one or more embodiments of the specification, before step S106, the method further includes followings.

Step A1, the first blockchain node receives a first registration request sent by the terminal device of the resource transfer user, wherein the first registration request includes first registration information.

The first registration information includes identity information (i.e., an identifier), first account information, contact information, or the like of the resource transfer user. Further, if the resource transfer user is an individual, the identity information of the resource transfer user may be an identity card number of the resource transfer user. If the resource transfer user is a user specified by an enterprise, the identity information of the resource transfer user may be identity information of the enterprise to which the resource transfer user belongs, for example, a document number of any one of documents such as a business license, an organization code certificate, a unified social credit code certificate, or a tax registration certificate of the enterprise.

Step A2, the first blockchain node determines a user identifier of the resource transfer user if determining that the first registration information is valid, generates a second registration record according to the first registration information, the user identifier of the resource transfer user, and an institution identifier of a resource transaction institution, and writes the second registration record to the blockchain.

When the resource transfer user is an individual, the first blockchain node matches the identity information of the resource transfer user with the user identity information stored in a first specified institution database, and matches the first account information with the user account information stored in a second specified institution database, and determines that the first registration information is valid if matching succeeds in both cases. When the resource transfer user is a user specified by an enterprise, the first blockchain node matches the identity information of the resource transfer user with the enterprise identity information stored in a third specified institution database, and matches the first account information with the user account information stored in a second specified institution database, and determines that the first registration information is valid if matching succeeds in both cases. Further, after determining that the first registration information is valid, the first blockchain node allocates a second account of the resource transfer user in the resource transaction institution to the resource transfer user. The second account may store a resource of the resource transfer user. The first blockchain node randomly allocates a user identifier to the resource transfer user, or uses the identity information of the resource transfer user as a user identifier of the resource transfer user. The first blockchain node associatively records information such as the first registration information, the user identifier of the resource transfer user, the second account, the institution identifier of the resource transaction institution, and correlations thereof, uses the recorded information as the first registration record information (i.e., a first registration record), and writes the first registration record information to the blockchain. The first specified institution, the second specified institution, and the third specified institution all are reliable third-party institutions, and are authoritative and legitimate. For example, when the resource is money, the first specified institution is the Public Security Bureau, the second specified institution is a bank, and the third specified institution is the Industry and Commerce Bureau. The first registration record information of the resource transfer user is written to the blockchain, to subsequently supervise, according to the first registration record information, whether the resource transaction institution has a transaction risk, to avoid that the resource transaction institution denies a transaction relationship with the resource transfer user when the resource transaction institution has a transaction risk.

Similarly, to effectively manage resource collection users, in one or more embodiments of the specification, before step S102, the method further includes followings.

Step B1, the first blockchain node receives a second registration request sent by the terminal device of the resource collection user, wherein the second registration request includes second registration information.

Step B2, the first blockchain node determines a user identifier of the resource collection user if determining that the second registration information is valid, generates second registration record information (i.e., a second registration record) according to the second registration information, the user identifier of the resource collection user, and the institution identifier of the resource transaction institution, and writes the second registration record information to the blockchain.

For an implementation method of step B1 and step B2, reference may be made to the implementation method of step A1 and step A2. Details are not described herein again.

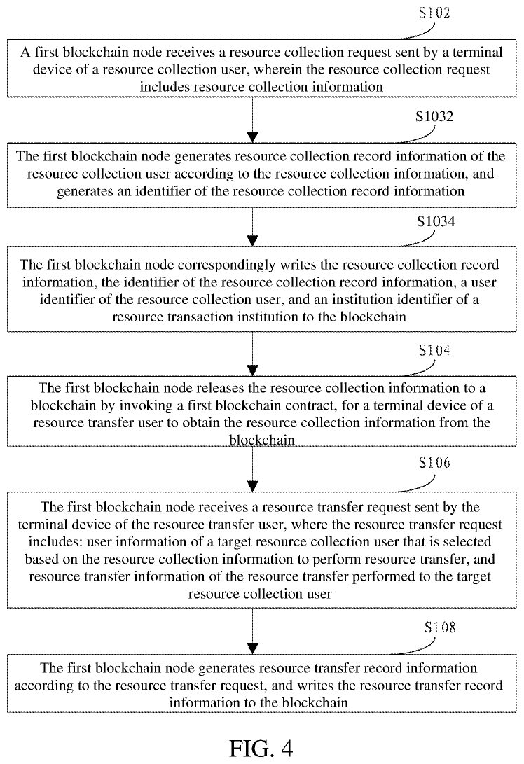

Each transaction includes a plurality of transaction stages, such as a resource collection initiation stage, a resource collection stage, a resource grant stage, and a resource return stage. There is usually a time interval between different transaction stages. As a result, transaction record information of different transaction stages of one transaction is dispersedly stored in a plurality of blocks of the blockchain. To ensure an association between transaction record information of different transaction stages of each transaction, in one or more embodiments of the specification, as shown in FIG. 4, after step S102, the method further includes followings.

Step S1032, the first blockchain node generates resource collection record information (i.e., a resource collection record) of the resource collection user according to the resource collection information, and generates an identifier of the resource collection record information.

Step S1034, the first blockchain node correspondingly writes the resource collection record information, the identifier of the resource collection record information, the user identifier of the resource collection user in correspondence with the resource collection record, and the institution identifier of the resource transaction institution to the blockchain.

The identifier of the resource collection record information is generated to associate all transaction records of a corresponding transaction according to the identifier, which makes it convenient for a second blockchain node and a tracing institution to obtain a transaction record of each transaction from the blockchain.

Considering that resources of one resource transfer user usually hardly meet a requirement of the resource collection user when a total quantity of resources to be collected by the resource collection user is relatively large, in one or more embodiments of the specification, a plurality of resource transfer users may perform resource transfer to the same resource collection user. Correspondingly, in step S108, the generating, by the first blockchain node, resource transfer record information (i.e., resource transfer record) according to the resource transfer request includes: recording, by the first blockchain node, a resource transfer quantity, information including the user identifier of the resource transfer user corresponding to the resource collection record, and an identifier of resource collection record information of the target resource collection user, if determining that a total quantity or a sum of a quantity of current collected resources and the resource transfer quantity is not greater than the total quantity of the to-be-collected resources, and using the recorded information as resource transfer record information of the resource transfer performed by the resource transfer user to the target resource collection user.

When receiving the resource transfer request sent by the resource transfer user, if a corresponding resource transfer record information in the blockchain according to the identifier of the resource collection record information of the target resource collection user is found, the first blockchain node calculates a total quantity of resource transfer quantities included in the found resource transfer record information as the quantity of the current collected resources. If no corresponding resource transfer record information in the blockchain according to the identifier of the resource collection record information of the target resource collection user is found, the first blockchain node determines that the quantity of the current collected resources is zero. The first blockchain node adds up the quantity of the current collected resources and the resource transfer quantity included in the resource transfer request, associatively records information including the resource transfer quantity, the user identifier of the resource transfer user, and the identifier of the resource collection record information of the target resource collection user if the addition result is not greater than the total quantity of the to-be-collected resources, and uses the recorded information as resource transfer record information (i.e. a resource transfer record) of the resource transfer performed by the resource transfer user to the target resource collection user.

When receiving the resource transfer request sent by the resource transfer user, the first blockchain node reads a quantity of current collected resources recorded in advance, adds up the read quantity of the current collected resources and the resource transfer quantity included in the resource transfer request, associatively records information including the resource transfer quantity, the user identifier of the resource transfer user, and the identifier of the resource collection record information of the target resource collection user if the addition result is not greater than the total quantity of the to-be-collected resources, and uses the recorded information as resource transfer record information of the resource transfer performed by the resource transfer user to the target resource collection user.

Further, when it is determined that the sum of the quantity of the current collected resources and the resource transfer quantity is equal to the total resource quantity of the to-be-collected resources, in step S108, after the generating, by the first blockchain node, resource transfer record information according to the resource transfer request, the method further includes followings.

Step C, the first blockchain node uses, if determining that a resource grant time specified by the resource collection user arrives, resources of the resource transfer quantity as collected resources, provides the current collected resources to the target resource collection user, generates resource grant record information (i.e., resource grant record), and writes the resource grant record information to the blockchain, wherein the resource grant record information includes the identifier of the resource collection record information of the target resource collection user.

Specifically, when determining that the sum of the quantity of the current collected resources and the resource transfer quantity is equal to the total resource quantity of the to-be-collected resources, that is, the resources to be collected by the resource collection user have been collected, the first blockchain node determines whether a current time is the same as the resource grant time specified by the resource collection user. If the current time is the same as the resource grant time, the first blockchain node uses resources of the resource transfer quantity as collected resources, transfers the current collected resources to an account corresponding to stored first account information of the target resource collection user or transfers the current collected resources to a second account of the target resource collection user in the resource transaction institution, that is, grants the collected resources to the target resource collection user, associatively records information such as the grant time and a grant quantity of the collected resources and the identifier of the resource collection record information of the target resource collection user, uses the recorded information as resource grant record information, and writes the resource grant record information to the blockchain.

Because a resource use fee that the resource collection user needs to pay starts to be calculated after the collected resources are provided to the resource collection user, the collected resources are provided to the resource collection user at the resource grant time specified by the resource collection user. During an actual application, when the resources to be collected by the resource collection user are collected but the resource grant time has not reached, the method may further include sending resource collection completion information to the resource collection user, and receiving a response message that is sent by the resource collection user and indicates whether the resource is granted immediately.

After the collected resources are provided to the target resource collection user, the target resource collection user needs to return the resources according to a resource return time included in the resource collection request. Correspondingly, the method further includes followings.

Step D, the first blockchain node receives a resource return request sent by a terminal device of a target resource transfer user, returns resources corresponding to the resource return request to a corresponding resource transfer user, generates resource return record information, and writes the resource return record information to the blockchain.

The resource return record information includes information such as a resource return quantity, a return time, and the identifier of the resource collection record information of the target resource collection user. Further, the returning resources corresponding to the resource return request to a corresponding resource transfer user may be transferring the resources corresponding to the resource return request to a second account of the resource transfer user in the resource transaction institution, or may be transferring the resources corresponding to the resource return request to an account corresponding to stored first account information of the resource transfer user.

The resource return record information is generated and written to the blockchain, so that it is ensured that the resource return operation of the target resource collection user is verifiable, to lower the risk that the resource transaction institution performs a malicious operation on the resources returned by the target resource collection user and does not timely return the resources to the resource transfer user and the risk of debt evasion of the target resource collection user.

If the target resource collection user fails to return the resources according to the resource return time, data such as identity information of the target resource collection user may be further provided to a credit institution, to warn the target resource collection user.

Further, after the resources corresponding to the resource return request are transferred to the second account of the resource transfer user in the resource transaction institution, or when resources are available in the second account of the resource transfer user, the resource transfer user may extract the resources stored in the second account and transfer the resources to the first account as required. Correspondingly, the method further includes followings.

Step E, the first blockchain node receives a resource extraction request sent by the terminal device of the resource transfer user, and extracts a resource of the resource transfer user, generates resource extraction record information (i.e., resource extraction record), and writes the resource extraction record information to the blockchain, wherein the resource extraction record information includes a resource extraction time, the user identifier of the resource transfer user, or the institution identifier of the resource transaction institution.

The resource extraction request includes a resource extraction quantity. When receiving the resource extraction request sent by the terminal device of the resource transfer user, the first blockchain node determines whether the resource extraction quantity is not greater than a quantity of all resources stored in the second account of the resource transfer user. If the resource extraction quantity is not greater than the quantity of all the resources stored in the second account of the resource transfer user, the first blockchain node transfers resources stored in the second account of the resource transfer user to the stored first account of the resource transfer user according to the resource extraction quantity, and associatively records information such as the resource extraction quantity, a resource extraction time, the user identifier of the resource transfer user, and the institution identifier of the resource transaction institution, uses the recorded information as resource extraction record information, and writes the resource extraction record information to the blockchain.

Usually, when more than a specific proportion of resource transfer users extract resources within a preset time period, a resource pool of the resource transaction institution may be empty, making it difficult to operate normally, that is, the resource transaction institution has a transaction risk. As the resource extraction record information of the resource transfer user is written to the blockchain, the second blockchain node can discover a potential transaction risk of the resource transaction institution according to the resource extraction record information as soon as possible, to avoid economic loss caused by the risk to the resource transfer user.

During an actual application, when the resource grant time specified by the resource collection user is reached, due to a resource collection reason or other factors of the resource collection user, the resource collection user may fail to attract enough resource transfer users to perform resource transfer to the resource collection user. In this case, the resource collection fails. Correspondingly, the method further includes followings.

Step F1, the first blockchain node sends resource collection failure information to the resource collection user if determining that the quantity of the current collected resources is not zero and is less than the total resource quantity of the to-be-collected resources when the resource grant time specified by the resource collection user is reached, and returns the current collected resources to a corresponding resource transfer user.

Step F2, the first blockchain node generates resource collection failure record information and resource return record information, and writes the resource collection failure record information and the resource return record information to the blockchain.

The resource collection failure record information includes information such as a resource collection failure time and the identifier of the resource collection record information of the resource collection user. The resource return record information includes information such as a resource return quantity, a return time, a user identifier of the resource transfer user, and the identifier of the resource collection record information of the resource collection user. The resource collection failure record information and the resource return record information are written to the blockchain, so that the integrity of transaction data corresponding to the resource collection request is ensured, and a user having transaction view permission may view a start point and an end point of each transaction in the blockchain.

According to the foregoing description, the resources to be collected by the resource collection user go through a plurality of states such as being collected, collected, collected but not granted, and granted. To represent a current state of the to-be-collected resources more clearly, to provide a full data basis for the second blockchain node to supervise whether the resource transaction institution has a transaction risk, in one or more embodiments of the specification, the method further includes followings.

Step G, the first blockchain node generates resource status record information (i.e., resource status record) according to a state of the to-be-collected resources, and writes the resource status record information to the blockchain, wherein the resource status record information includes status information representing the state of the to-be-collected resources and the identifier of the resource collection record information of the target resource collection user, for the second blockchain node to supervise, according to the resource status record information, whether the resource transaction institution has a transaction risk.

After step S1032, the first blockchain node generates first status record information. The first status record information includes information such as status information representing that the to-be-collected resources are in a to-be-collected state and the identifier of the resource collection record information of the target resource collection user. After step S104, the first blockchain node generates second status record information. The second status record information includes information such as status information representing that the to-be-collected resources are in a being collected state and the identifier of the resource collection record information of the target resource collection user. When determining that the sum of the quantity of the current collected resources and the resource transfer quantity is equal to the total resource quantity of the to-be-collected resources, the first blockchain node generates third status record information. The third status record information includes information such as status information representing that the to-be-collected resources are in a collected state and the identifier of the resource collection record information of the target resource collection user. After the to-be-collected resources are collected, before the resource grant time specified by the resource collection user is reached, the first blockchain node generates fourth status record information. The fourth status record information includes information such as status information representing that the to-be-collected resources are in a collected but not granted state and the identifier of the resource collection record information of the target resource collection user. After step D, the first blockchain node generates fifth status record information. The fifth status record information includes information such as status information representing that the to-be-collected resources are in a granted state and the identifier of the resource collection record information of the target resource collection user.

To enhance users' good opinion and trust in the resource transaction institution, the resource transaction institution often releases bulletin information, such as various honor awards obtained in an operating process and various transaction data, of an operating status of the resource transaction institution on a website or an application (APP) of the resource transaction institution, to achieve an advertising benefit, making resource transfer users think that the resource transaction institution is well supported and highly secured. Also, the resource transaction institution sometimes may have a transaction risk, and revoke the released bulletin information. In this case, a large quantity of resource transfer users access the website or the APP of the resource transaction institution, causing a service crash. As a result, the resource transfer users cannot immediately obtain the bulletin information of the resource transaction institution, and cannot obtain more proof information about the resource transaction institution. It is difficult for an investor to defend rights, and a criminal even takes advantages of the time to transfer a resource.

In view of this, in one or more embodiments of the specification, the method further includes: obtaining, by the first blockchain node, bulletin information of an operating status of a resource transaction institution released by a user on a website or an application (APP) of the resource transaction institution on a terminal device of the user; generating, by the first blockchain node when a user of the resource transaction institution releases bulletin information of an operating status of the resource transaction institution on the website or the APP of the resource transaction institution using a terminal device of the user, bulletin release record information (i.e., bulletin release record) according to the bulletin information, and writing the bulletin release record information to the blockchain, wherein the bulletin release record information includes key information of the bulletin information and the institution identifier of the resource transaction institution; obtaining, by the first blockchain node, a revocation of the bulletin information by the user on a website or an application (APP) of the resource transaction institution on a terminal device of the user; and generating, by the first blockchain node when the user of the resource transaction institution revokes the bulletin information using the terminal device of the user, bulletin revocation record information (i.e., a bulletin revocation record) according to the revoked bulletin information, and writing the bulletin revocation record information to the blockchain, wherein the bulletin revocation record information includes a revocation time at which the bulletin information is revoked and the institution identifier of the resource transaction institution.

The website or the APP of the resource transaction institution provides a data obtaining interface to the first blockchain node. When the user of the resource transaction institution releases the bulletin information of the operating status of the resource transaction institution on the website or the APP of the resource transaction institution using the terminal device of the user, the first blockchain node obtains the key information of the released bulletin information through the data obtaining interface, associatively records information such as the obtained key information, a release time of the bulletin information, and the institution identifier of the resource transaction institution, uses the recorded information as bulletin release record information, and writes the bulletin release record information to the blockchain. When the user of the resource transaction institution revokes the bulletin information of the operating status of the resource transaction institution using the terminal device of the user, the first blockchain node obtains key information of the revoked bulletin information through the data obtaining interface, associatively records information such as the obtained key information, a revocation time of the bulletin information, and the institution identifier of the resource transaction institution, uses the recorded information as bulletin revocation record information, and writes the bulletin revocation record information to the blockchain. In this way, the release record information of the bulletin information is written to the blockchain, so that even if the resource transaction institution deletes the bulletin information from the website or the APP of the resource transaction institution, the resource transaction institution cannot erase the fact that the resource transaction institution released the bulletin information. Therefore, a resource transfer user is not passive due to a failure to obtain related proof information of the resource transaction institution when the resource transaction institution has a transaction risk. In addition, the second blockchain node can find a potential transaction risk of the financial institution according to the bulletin release record information and the bulletin revocation record information as soon as possible.

When the resource transaction institution is established, the first blockchain node further writes registration information of the resource transaction institution, identity information of a person in charge of the resource transaction institution, and the like to the blockchain.

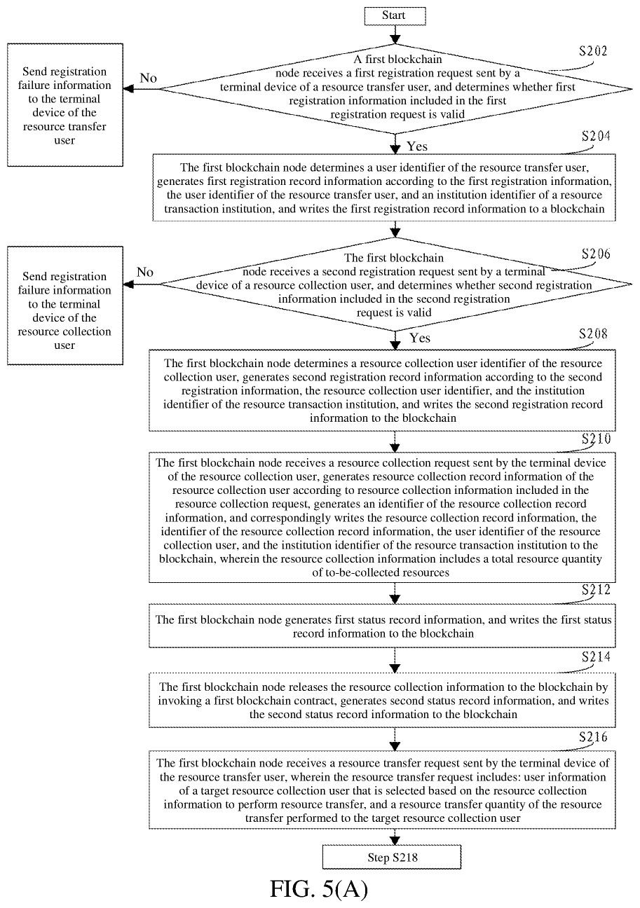

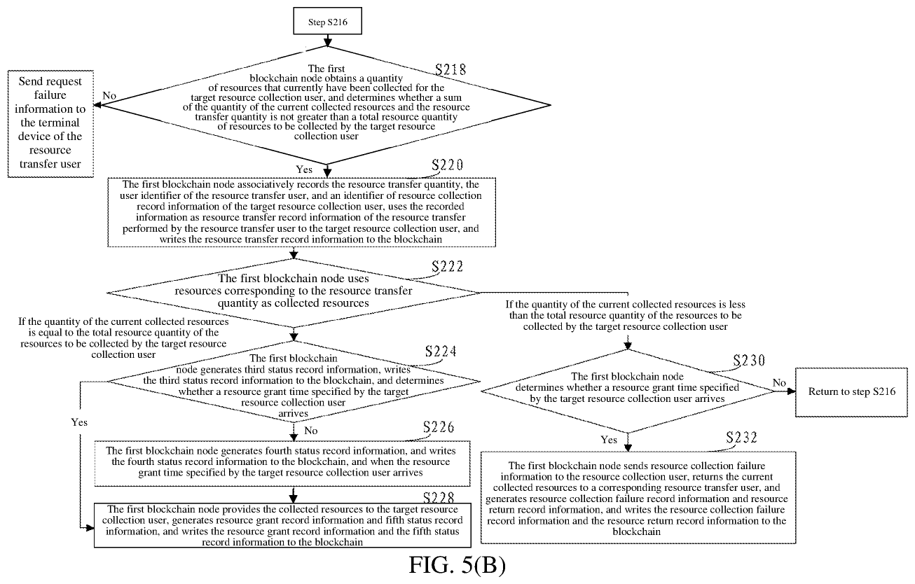

In an embodiment, as shown in FIG. 5(A) and FIG. 5(B), the method includes followings.

Step S202, a first blockchain node receives a first registration request sent by a terminal device of a resource transfer user, determines whether first registration information included in the first registration request is valid, and performs step S204 if the first registration information is valid, otherwise, sends registration failure information to the terminal device of the resource transfer user.

Step S204, the first blockchain node determines a user identifier of the resource transfer user, generates first registration record information according to the first registration information, the user identifier of the resource transfer user, and an institution identifier of a resource transaction institution, and writes the first registration record information to a blockchain.

Step S206, the first blockchain node receives a second registration request sent by a terminal device of a resource collection user, determines whether second registration information included in the second registration request is valid, and performs step S208 if the second registration information is valid, otherwise, sends registration failure information to the terminal device of the resource collection user.

Step S208, the first blockchain node determines a resource collection user identifier of the resource collection user, generates second registration record information according to the second registration information, the resource collection user identifier, and the institution identifier of the resource transaction institution, and writes the second registration record information to the blockchain.

Step S210, the first blockchain node receives a resource collection request sent by the terminal device of the resource collection user, generates resource collection record information of the resource collection user according to resource collection information included in the resource collection request, generates an identifier of the resource collection record information, and correspondingly writes the resource collection record information, the identifier of the resource collection record information, the user identifier of the resource collection user, and the institution identifier of the resource transaction institution to the blockchain, wherein the resource collection information includes a total resource quantity of to-be-collected resources.

Step S212, the first blockchain node generates first status record information, and writes the first status record information to the blockchain.

Step S214, the first blockchain node releases the resource collection information to the blockchain by invoking or otherwise using a first blockchain contract, generates second status record information, and writes the second status record information to the blockchain.

Step S216, the first blockchain node receives a resource transfer request sent by the terminal device of the resource transfer user, wherein the resource transfer request includes user information of a target resource collection user that is selected based on the resource collection information to perform resource transfer to, and a resource transfer quantity of the resource transfer performed to the target resource collection user.

Step S218, the first blockchain node obtains a quantity of resources that currently have been collected for the target resource collection user, determines whether a sum of the quantity of the current collected resources and the resource transfer quantity is not greater than a total resource quantity of resources to be collected by the target resource collection user, and performs step S220 if the sum of the quantity of the current collected resources and the resource transfer quantity is not greater than the total resource quantity of the resources to be collected by the target resource collection user, otherwise, sends request failure information to the terminal device of the resource transfer user.

When the sum of the quantity of the current collected resources and the resource transfer quantity is greater than the total resource quantity of the resources to be collected by the target resource collection user, that is, exceeds the total quantity of the resources to be collected by the target resource collection user, because the target resource collection user needs to pay an additional fee for use of an excess resource, it is considered that the resource transfer request fails, and the request failure information is sent to the resource transfer user. Further, when receiving the request failure information, the resource transfer user may adjust the resource transfer quantity, and then resend a resource transfer request to the first blockchain node.

Step S220, the first blockchain node associatively records information including the resource transfer quantity, the user identifier of the resource transfer user, and an identifier of resource collection record information of the target resource collection user, uses the recorded information as resource transfer record information of the resource transfer performed by the resource transfer user to the target resource collection user, and writes the resource transfer record information to the blockchain.

Step S222, the first blockchain node uses resources corresponding to the resource transfer quantity as collected resources, and performs step S224 if the quantity of the current collected resources is equal to the total resource quantity of the resources to be collected by the target resource collection user, or performs step S230 if the quantity of the current collected resources is less than the total resource quantity of the resources to be collected by the target resource collection user.

Step S224, the first blockchain node generates third status record information, writes the third status record information to the blockchain, determines whether a resource grant time specified by the target resource collection user arrives, and performs step S228 if the resource grant time arrives, otherwise, performs step S226.

Step S226, the first blockchain node generates fourth status record information, writes the fourth status record information to the blockchain, and performs step S228 when the resource grant time specified by the target resource collection user arrives.

Step S228, the first blockchain node provides the collected resources to the target resource collection user, generates resource grant record information and fifth status record information, and writes the resource grant record information and the fifth status record information to the blockchain.

Step S230, the first blockchain node determines whether a resource grant time specified by the target resource collection user arrives, and performs step S232 if the resource grant time arrives, otherwise, returns to step S216.

Step S232, the first blockchain node sends resource collection failure information to the resource collection user, returns the current collected resources to a corresponding resource transfer user, and generates resource collection failure record information and resource return record information, and writes the resource collection failure record information and the resource return record information to the blockchain.

Step S202 to step S204 may be performed before, after, or simultaneously with step S206 to step S208. For a specific implementation process of step S202 to step S232, reference may be made to the foregoing related descriptions. Details are not described herein again.

In the one or more embodiments of the specification, a first blockchain node: releases resource collection information to a blockchain by invoking or otherwise using a first blockchain contract when receiving a resource collection request sent by a terminal device of a resource collection user, for a terminal device of a resource transfer user to obtain the resource collection information from the blockchain, wherein the resource collection request includes the resource collection information; and when receiving a resource transfer request sent by a terminal device of a resource transfer user, generates, according to the resource transfer request, resource transfer record information of resource transfer performed by the resource transfer user to a target resource collection user, and writes the resource transfer record information to the blockchain. In one or more embodiments of the specification, a transaction is performed in a reliable environment of the blockchain, so that a transaction process is public and transparent and is available to a plurality of parties, which achieves a deterrent effect to illegal and other behavior. In addition, transaction record information such as the resource transfer record information is stored in the blockchain, so that it is ensured that chained data is tamperproof and publicly available, problems such as data loss and data fraud are effectively avoided, problems such as difficulties in testifying and defending rights of the resource transfer user are resolved, and an effective data basis is provided for transaction supervision.

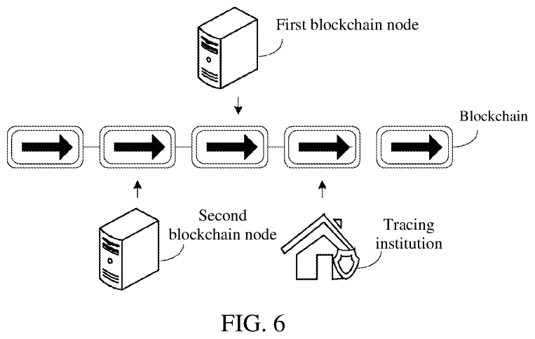

FIG. 6 is a schematic diagram of an application scenario of a blockchain-based transaction supervision system, according to one or more embodiments of the specification. As shown in FIG. 6, the system includes: a first blockchain node, a second blockchain node, and a tracing institution. The first blockchain node, the second blockchain node, and the tracing institution all access a blockchain. The tracing institution is, for example, the Public Security Bureau or the Transport Bureau.

The first blockchain node writes transaction record information of a resource transaction institution to the blockchain.

The second blockchain node obtains the transaction record information of the resource transaction institution from the blockchain, determines, based on the obtained transaction record information by invoking or otherwise using a second blockchain contract, whether the resource transaction institution has a transaction risk, and sends alert information to the tracing institution using the second blockchain contract when determining that the resource transaction institution has a transaction risk.

The tracing institution performs tracing processing on the resource transaction institution when receiving the alert information sent by the second blockchain node. For example, the Public Security Bureau queries the blockchain for the transaction record information of the resource transaction institution, and obtains key information such as quantities of remaining resources and unreturned resources of the resource transaction institution. The Transport Bureau obtains the whereabouts of a relevant person in charge of the resource transaction institution, to prevent the relevant person in charge of the resource transaction institution from escaping to evade legal liability. In addition, when necessary, the Transport Bureau may further upload a whereabouts video of the relevant person in charge of the resource transaction institution to the blockchain, for the Public Security Bureau to determine a location and the like of the person in charge according to the whereabouts video.

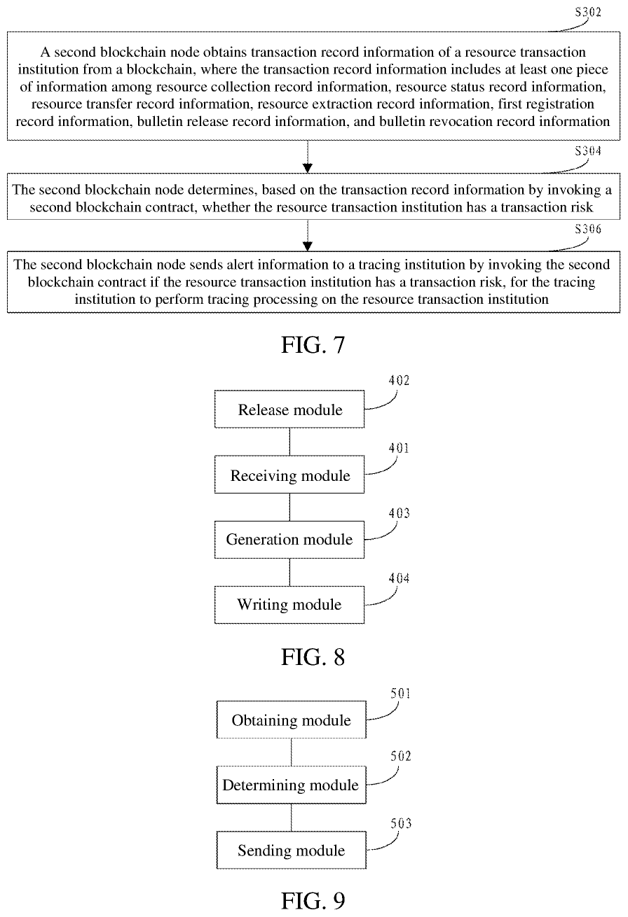

FIG. 7 is a schematic flowchart of a blockchain-based transaction supervision method, according to one or more embodiments of the specification. The method in FIG. 7 may be performed by the second blockchain node in FIG. 6. As shown in FIG. 7, the method includes followings.

Step S302, the second blockchain node obtains transaction record information of a resource transaction institution from a blockchain, wherein the transaction record information includes at least one piece of information among resource collection record information, resource status record information, resource transfer record information, resource extraction record information, first registration record information, bulletin release record information, and bulletin revocation record information.

Step S304, the second blockchain node determines, based on the transaction record information by invoking or otherwise using a second blockchain contract, whether the resource transaction institution has a transaction risk.

Step S306, the second blockchain node sends alert information to a tracing institution using the second blockchain contract if the resource transaction institution has a transaction risk, for the tracing institution to perform tracing processing on the resource transaction institution.

In the one or more embodiments of the specification, a transaction risk of a resource transaction institution can be found based on transaction record information in a blockchain as soon as possible, to timely perform tracing processing on the resource transaction institution, so that a transaction performed by the resource transaction institution is effectively supervised, and the occurrence that the resource transaction institution evades the responsibility or escapes is effectively reduced. In addition, a resource transfer user is not required to provide much proof in a supervision process, costs of defending rights of the resource transfer user are reduced, and supervision efficiency is improved.

When the resource transaction institution collects a large quantity of resources but does not send the resources to resource collection users, it is possible that the resource transaction institution may perform an illegal operation using collected resources. Further, within a specific time, when a large quantity of resource transfer users extract resources of the resource transfer users in the resource transaction institution, a resource pool of the resource transaction institution may be in shortage of resources. The resource shortage may cause the resource transaction institution to adopt an unlawful policy due to difficulties in operation. The extraction may be caused by negative news about the resource transaction institution that the resource transfer users heard, that is, the resource transaction institution may have an operating problem. In addition, when the resource transaction institution releases some bulletin messages unfavorable to operation or revokes a large quantity of released bulletin messages, the resource transaction institution may have risks such as being unable to pay back the resources of the resource transfer users or bankruptcy. For such considerations, in one or more embodiments of the specification, the resource collection record information includes a resource grant time, the resource extraction record information includes a resource extraction time and a user identifier of a resource transfer user, the bulletin revocation record information includes a revocation time at which bulletin information is revoked.

Step S304 includes invoking or otherwise using, by the second blockchain node, the second blockchain contract, and performing at least one of the following operations based on the second blockchain contract: determining that the resource transaction institution has a transaction risk if determining, according to the resource collection record information and the resource status record information, that there is a transaction with a resource grant time earlier than a current time and a resource in a collected state but not in a granted state, and a resource quantity of the collected resources exceeds a preset quantity; calculating, according to the first registration record information and the resource extraction record information, a first proportion of resource transfer users performing a resource extraction operation within a first preset time period in all resource transfer users registered with the resource transaction institution; and determining that the resource transaction institution has a transaction risk if the calculated first proportion exceeds a first preset proportion; determining, according to the bulletin release record information, whether the bulletin information released by the resource transaction institution meets a preset condition, and determining that the resource transaction institution has a transaction risk if the bulletin information meets the preset condition; or calculating, according to the bulletin release record information and the bulletin revocation record information, a second proportion of bulletin information revoked within a second preset time period in all bulletin information released by the resource transaction institution, and determining that the resource transaction institution has a transaction risk if the calculated second proportion exceeds a second preset proportion.

The process of determining, based on the resource collection record information and the resource status record information, that the resource transaction institution has a transaction risk includes: obtaining target resource collection record information with a resource grant time earlier than a current time from the resource collection record information; obtaining corresponding target resource status record information from the resource status record information according to an identifier of the target resource collection record information; and determining that the resource transaction institution has a transaction risk if status information in the target resource status record information represents that a resource is in a collected state but not in a granted state, and a resource quantity of the collected but not granted resources exceeds a preset amount.

The process of determining, based on the first registration record information and the resource extraction record information, that the resource transaction institution has a transaction risk includes: counting pieces of first registration record information included in the transaction record information, to obtain a first quantity of all resource transfer users registered with the resource transaction institution; obtaining target resource extraction record information with a resource extraction time within a first preset time period from the resource extraction record information, counting user identifiers of resource transfer users included in the target resource extraction record information, obtaining a second quantity of resource transfer users performing a resource extraction operation within the first preset time period, and dividing the second quantity by the first quantity to obtain a first proportion of the resource transfer users performing a resource extraction operation; and comparing the calculated first proportion with a first preset proportion, and determining that the resource transaction institution has a transaction risk if the calculated first proportion exceeds the first preset proportion.

The process of determining, based on the bulletin release record information, that the resource transaction institution has a transaction risk includes: obtaining key information included in the bulletin release record information, when the key information represents a bulletin type of bulletin information, determining that the resource transaction institution has a transaction risk if determining that the obtained key information represents a preset bulletin type, wherein the preset bulletin type is, for example, a service type that a resource cannot be extracted, an operating status type representing that the resource transaction institution has operation difficulties, or an operating status type representing that the resource transaction institution exits benignly; and when the key information represents main content of the bulletin information, determining that the resource transaction institution has a transaction risk if determining that the key information includes a preset field, wherein the preset field includes, for example, a resource cannot be extracted, operation difficulties, or exit.

The process of determining, based on the bulletin release record information and the bulletin revocation record information, that the resource transaction institution has a transaction risk includes: obtaining target bulletin revocation record information with a revocation time within a second preset time period from the bulletin revocation record information, and obtaining a third quantity of pieces of target bulletin revocation record information; and obtaining a fourth quantity of bulletin release record information included in the transaction record information, dividing the third quantity by the fourth quantity to obtain a second proportion of bulletin information revoked within the second preset time period in all the bulletin information released by the resource transaction institution, and determining that the resource transaction institution has a transaction risk if the obtained second proportion exceeds a second preset proportion.

The first preset proportion and the second preset proportion may be the same or may be different. The first preset time period and the second preset time period may be the same or may be different. The first preset proportion, the second preset proportion, the first preset time period, and the second preset time period all may be customized as required during an actual application. The transaction record information stored in the blockchain is analyzed to evaluate whether the resource transaction institution has a transaction risk, so that a transaction performed by the resource transaction institution is effectively supervised, and the occurrence that the resource transaction institution evades the responsibility or escapes is significantly reduced.

During an actual application, a website or an APP of the resource transaction institution is usually provided with a complaint module, for a user to make a complaint about a service or the like of the resource transaction institution. The user complaint behavior of the reflects that the resource transaction institution may have an operating problem to some extent.

In one or more embodiments of the specification, the method further includes: counting, by the second blockchain node using a statistical task included in the second blockchain contract or a third blockchain contract, an operation quantity of operations performed within preset period on the complaint module included on the website or the APP of the resource transaction institution, and determining that the resource transaction institution has a transaction risk if the counted operation quantity is greater than a preset quantity; and sending, by the second blockchain node, alert information to the tracing institution using the second blockchain contract or the third blockchain contract.

The second blockchain contract includes interface information of the complaint module included on the website or the APP of the resource transaction institution, for the statistical task to count, according to the interface information, a quantity of operations that the corresponding complaint module is triggered. In an embodiment, the third blockchain contract is deployed in the blockchain, and the third blockchain contract includes interface information of the complaint module included on the website or the APP of the resource transaction institution, for the statistical task to count, according to the interface information, a quantity of operations that the corresponding complaint module is triggered.

In the one or more embodiments of the specification, a second blockchain node obtains transaction record information of a resource transaction institution from a blockchain, wherein the transaction record information includes at least one piece of information among resource collection record information, resource status record information, resource transfer record information, resource extraction record information, first registration record information, bulletin release record information, and bulletin revocation record information. The second blockchain node determines, based on the transaction record information by invoking or otherwise using a second blockchain contract, whether the resource transaction institution has a transaction risk, and sends alert information to a tracing institution by invoking or otherwise using the second blockchain contract if the resource transaction institution has a transaction risk, for the tracing institution to perform tracing processing on the resource transaction institution. In one or more embodiments of the specification, the transaction risk of the resource transaction institution can be found based on the transaction record information in the blockchain as soon as possible, to timely perform tracing processing on the resource transaction institution, so that a transaction performed by the resource transaction institution is effectively supervised, and the occurrence that the resource transaction institution evades the responsibility or escapes is effectively reduced. In addition, a resource transfer user is not required to provide much proof in a supervision process, costs of defending rights of the resource transfer user are reduced, and supervision efficiency is improved.

Corresponding to the blockchain-based transaction method described in FIG. 2 to FIG. 5, based on the same technical idea, one or more embodiments of the specification further provide a blockchain-based transaction apparatus. FIG. 8 is a schematic diagram of a blockchain-based transaction apparatus, according to one or more embodiments of the specification. The apparatus is configured to perform the blockchain-based transaction method described in FIG. 2 to FIG. 5.

As shown in FIG. 8, the apparatus includes: a receiving module 401, which is configured to receive a resource collection request sent by a terminal device of a resource collection user, wherein the resource collection request includes resource collection information; a release module 402, which is configured to release the resource collection information to a blockchain by invoking or otherwise using a first blockchain contract, for a terminal device of a resource transfer user to obtain the resource collection information from the blockchain, wherein the receiving module 401 is configured to further receive a resource transfer request sent by the terminal device of the resource transfer user, wherein the resource transfer request includes user information of a target resource collection user that is selected based on the resource collection information to perform resource transfer to, and resource transfer information of the resource transfer performed to the target resource collection user; a generation module 403, which is configured to generate resource transfer record information according to the resource transfer request; and a write module 404, which is configured to write the resource transfer record information to the blockchain.

In the one or more embodiments of the specification, a transaction is performed in a reliable environment of a blockchain, so that a transaction process is public and transparent and is available to a plurality of parties, which achieves a deterrent effect to illegal and other behaviors. In addition, transaction transfer record information is written to the blockchain, so that it is ensured that chained data is tamperproof and publicly available, problems such as data loss and data fraud are effectively avoided, and problems such as difficulties in testifying and defending rights of a resource transfer user are resolved.

In an embodiment, the resource collection information includes a total resource quantity of to-be-collected resources, and the resource transfer information includes a resource transfer quantity.

After the receiving module 401 configured to receive the resource collection request sent by the terminal device of the resource collection user, the generation module 403 is further configured to generate resource collection record information of the resource collection user according to the resource collection information, and generate an identifier of the resource collection record information.

The write module 404 is further configured to correspondingly write the resource collection record information, the identifier of the resource collection record information, a user identifier of the resource collection user, and an institution identifier of a resource transaction institution to the blockchain, and associatively record the resource transfer quantity, a user identifier of the resource transfer user, and an identifier of resource collection record information of the target resource collection user if it is determined that a sum of a quantity of current collected resources and the resource transfer quantity is not greater than the total resource quantity of the to-be-collected resources, and use the recorded information as resource transfer record information of the resource transfer performed by the resource transfer user to the target resource collection user.

In an embodiment, the resource collection information includes a resource grant time, and the apparatus further includes a resource grant module.

When the write module 404 determines that the sum of the quantity of the current collected resources and the resource transfer quantity is equal to the total resource quantity of the to-be-collected resources, after the generation module 403 generates the resource transfer record information according to the resource transfer request, the resource grant module is configured to use, if determining that the resource grant time arrives, resources corresponding to the resource transfer quantity as collected resources, provides the current collected resources to the target resource collection user, generates resource grant record information, and writes the resource grant record information to the blockchain, wherein the resource grant record information includes the identifier of the resource collection record information of the target resource collection user.

In an embodiment, the apparatus further includes a resource status record module.

After the receiving module 401 is configured to receive the resource transfer request sent by the terminal device of the resource transfer user, the resource status record module generates resource status record information according to a state of the to-be-collected resources, and write the resource status record information to the blockchain, wherein the resource status record information includes status information representing the state of the to-be-collected resources and the identifier of the resource collection record information of the target resource collection user.

In an embodiment, the apparatus further includes a resource extraction module.

The resource extraction module is configured to receive a resource extraction request sent by the terminal device of the resource transfer user, extract a resource of the resource transfer user according to the resource extraction request, generate resource extraction record information, and write the resource extraction record information to the blockchain, wherein the resource extraction record information includes a resource extraction time, a user identifier of the resource transfer user, and the institution identifier of the resource transaction institution.

In an embodiment, the apparatus further includes a bulletin recording module.

The bulletin recording module is configured to generate, when a user of the resource transaction institution releases bulletin information of an operating status of the resource transaction institution on a website or an APP of the resource transaction institution using a terminal device of the user, bulletin release record information according to the bulletin information, and write the bulletin release record information to the blockchain, wherein the bulletin release record information includes key information of the bulletin information and the institution identifier of the resource transaction institution.

The bulletin recording module is configured to generate, when the user of the resource transaction institution revokes the bulletin information using the terminal device of the user, bulletin revocation record information according to the revoked bulletin information, and write the bulletin revocation record information to the blockchain, wherein the bulletin revocation record information includes a revocation time at which the bulletin information is revoked and the institution identifier of the resource transaction institution.

In an embodiment, the apparatus further includes a registration module.

Before the receiving module 401 is configured to receive the resource transfer request sent by the terminal device of the resource transfer user, the registration module receives a first registration request sent by the terminal device of the resource transfer user, wherein the first registration request includes first registration information.

The registration module is configured to determine the user identifier of the resource transfer user if the first blockchain node determines that the first registration information is valid, generates first registration record information according to the first registration information, the user identifier of the resource transfer user, and the institution identifier of the resource transaction institution, and write the first registration record information to the blockchain.

The blockchain-based transaction apparatus provided in the one or more embodiments of the specification can: release resource collection information to a blockchain by invoking or otherwise using a first blockchain contract when receiving a resource collection request sent by a terminal device of a resource collection user, for a terminal device of a resource transfer user to obtain the resource collection information from the blockchain, wherein the resource collection request includes the resource collection information; and when receiving a resource transfer request sent by a terminal device of a resource transfer user, generate, according to the resource transfer request, resource transfer record information of resource transfer performed by the resource transfer user to a target resource collection user, and write the resource transfer record information to the blockchain. In one or more embodiments of the specification, a transaction is performed in a reliable environment of the blockchain, so that a transaction process is public and transparent and is available to a plurality of parties, which achieves a deterrent effect to illegal and other behavior. In addition, transaction record information such as the resource transfer record information is stored in the blockchain, so that it is ensured that chained data is tamperproof and publicly available, problems such as data loss and data fraud are effectively avoided, problems such as difficulties in testifying and defending rights of the resource transfer user are resolved, and an effective data basis is provided for transaction supervision.

Since the embodiments of the blockchain-based transaction apparatus in the specification and the embodiments of the blockchain-based transaction method in the specification are based on the same idea, for specific implementation of the embodiments, reference may be made to the foregoing implementation of the blockchain-based transaction method, and details are not described again.

Corresponding to the blockchain-based transaction supervision method described in FIG. 7, based on the same technical idea, one or more embodiments of the specification further provide a blockchain-based transaction supervision apparatus. FIG. 9 is a schematic diagram of modular composition of a blockchain-based transaction supervision apparatus, according to one or more embodiments of the specification. The apparatus is configured to perform the blockchain-based transaction supervision method described in FIG. 7.

As shown in FIG. 9, the apparatus includes: an obtaining module 501, which is configured to obtain transaction record information of a resource transaction institution from a blockchain, wherein the transaction record information includes at least one piece of information among resource collection record information, resource status record information, resource transfer record information, resource extraction record information, first registration record information, bulletin release record information, and bulletin revocation record information; a determining module 502, which is configured to determine, based on the transaction record information by invoking or otherwise using a second blockchain contract, whether the resource transaction institution has a transaction risk; and a sending module 503, which is configured to send alert information to a tracing institution by invoking or otherwise using the second blockchain contract when the determining module determines that the resource transaction institution has a transaction risk, for the tracing institution to perform tracing processing on the resource transaction institution.

In the one or more embodiments of the specification, a transaction risk of a resource transaction institution can be found based on transaction record information in a blockchain as soon as possible, to timely perform tracing processing on the resource transaction institution, so that a transaction performed by the resource transaction institution is effectively supervised, and the occurrence that the resource transaction institution evades the responsibility or escapes is effectively reduced. In addition, a resource transfer user is not required to provide much proof in a supervision process, costs of defending rights of the resource transfer user are reduced, and supervision efficiency is improved.

In an embodiment, the resource collection record information includes a resource grant time, the resource extraction record information includes a resource extraction time and a user identifier of a resource transfer user, and the bulletin revocation record information includes a revocation time at which bulletin information is revoked.

The determining module 502 is configured to invoke the second blockchain contract, and perform at least one of the following operations based on the second blockchain contract: determining that the resource transaction institution has a transaction risk if determining, according to the resource collection record information and the resource status record information, that there is a transaction with a resource grant time earlier than a current time and a resource in a collected state but not granted state, and a resource quantity of collected resources exceeds a preset quantity; calculating, according to the first registration record information and the resource extraction record information, a first proportion of resource transfer users performing a resource extraction operation within a first preset time period in all resource transfer users registered with the resource transaction institution, and determining that the resource transaction institution has a transaction risk if the calculated first proportion exceeds a first preset proportion; determining, according to the bulletin release record information, whether the bulletin information released by the resource transaction institution meets a preset condition, and determining that the resource transaction institution has a transaction risk if the bulletin information meets the preset condition; or calculating, according to the bulletin release record information and the bulletin revocation record information, a second proportion of bulletin information revoked within a second preset time period in all bulletin information released by the resource transaction institution, and determining that the resource transaction institution has a transaction risk if the calculated second proportion exceeds a second preset proportion.

In an embodiment, the determining module 502 is further configured to count, using a statistical task included in the second blockchain contract or a third blockchain contract, an operation quantity of operations performed within preset period on a complaint module included on a website or an APP of the resource transaction institution, determine that the resource transaction institution has a transaction risk if the counted operation quantity is greater than a preset quantity, and send alert information to the tracing institution by invoking or otherwise using the second blockchain contract or the third blockchain contract.

The blockchain-based transaction supervision apparatus provided in the one or more embodiments of the specification obtains transaction record information of a resource transaction institution from a blockchain, wherein the transaction record information includes at least one piece of information among resource collection record information, resource status record information, resource transfer record information, resource extraction record information, first registration record information, bulletin release record information, and bulletin revocation record information; determines, based on the transaction record information by invoking or otherwise using a second blockchain contract, whether the resource transaction institution has a transaction risk; and sends alert information to a tracing institution by invoking or otherwise using the second blockchain contract if the resource transaction institution has a transaction risk, for the tracing institution to perform tracing processing on the resource transaction institution. In one or more embodiments of the specification, the transaction risk of the resource transaction institution can be found based on the transaction record information in the blockchain as soon as possible, to timely perform tracing processing on the resource transaction institution, so that a transaction performed by the resource transaction institution is effectively supervised, and the occurrence that the resource transaction institution evades the responsibility or escapes is effectively reduced. In addition, a resource transfer user is not required to provide much proof in a supervision process, costs of defending rights of the resource transfer user are reduced, and supervision efficiency is improved.

Since the embodiments of the blockchain-based transaction supervision apparatus in the specification and the embodiments of the blockchain-based transaction supervision method in the specification are based on the same idea, for specific implementation of the embodiments, reference may be made to the foregoing implementation of the blockchain-based transaction supervision method, and details are not described again.

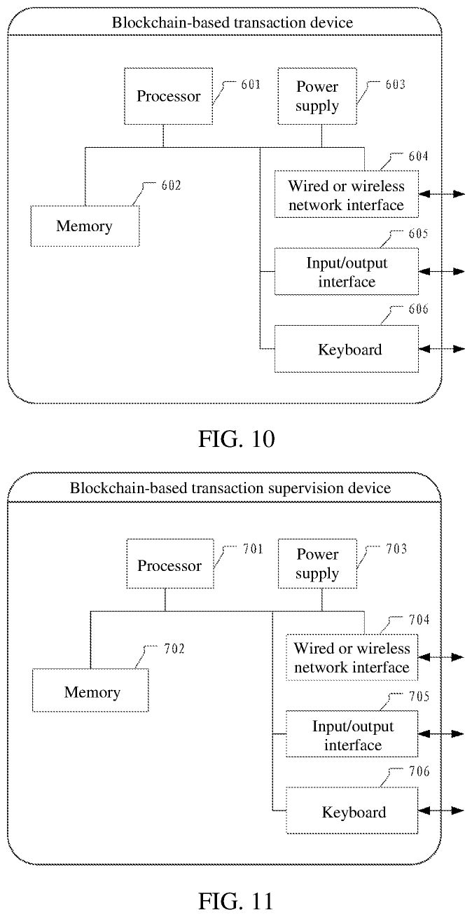

Further, corresponding to the method shown in FIG. 2 to FIG. 5, based on the same technical idea, one or more embodiments of the specification further provide a blockchain-based transaction device. The device is configured to perform the blockchain-based transaction method. FIG. 10 is a schematic structural diagram of the blockchain-based transaction device, according to the embodiments of the specification.

As shown in FIG. 10, the blockchain-based transaction device may vary greatly with different configurations or performance, and may include one or more processors 601 and memories 602. The memory 602 may store one or more application programs or data. The memory 602 may be a transient or persistent storage. The application program stored in the memory 602 may include one or more modules (not shown). Each module may include a series of computer executable instructions in the blockchain-based transaction device. Furthermore, the processor 601 may be configured to communicate with the memory 602, and execute, on the blockchain-based transaction device, a series of computer executable instructions in the memory 602. The blockchain-based transaction device may further include one or more power supplies 603, one or more wired or wireless network interfaces 604, one or more input/output interfaces 605, one or more keyboards 606, and the like.

In an embodiment, the blockchain-based transaction device includes a memory and one or more programs. The one or more programs are stored in the memory, the one or more programs may include one or more modules, each module may include a series of computer executable instructions in the blockchain-based transaction device, and one or more processors are configured to execute the one or more programs including the following computer executable instructions to: receive a resource collection request sent by a terminal device of a resource collection user, wherein the resource collection request includes resource collection information; release the resource collection information to a blockchain by invoking or otherwise using a first blockchain contract, for a terminal device of a resource transfer user to obtain the resource collection information from the blockchain; receive a resource transfer request sent by the terminal device of the resource transfer user, wherein the resource transfer request includes: user information of a target resource collection user that is selected based on the resource collection information to perform resource transfer to, and resource transfer information of the resource transfer performed to the target resource collection user; and generate resource transfer record information according to the resource transfer request, and write the resource transfer record information to the blockchain.

In the one or more embodiments of the specification, a transaction is performed in a reliable environment of a blockchain, so that a transaction process is public and transparent and is available to a plurality of parties, which achieves a deterrent effect to illegal and other behavior. In addition, transaction transfer record information is written to the blockchain, so that it is ensured that chained data is tamperproof and publicly available, problems such as data loss and data fraud are effectively avoided, and problems such as difficulties in testifying and defending rights of a resource transfer user are resolved.

In an embodiment, when the computer executable instructions are executed, the resource collection information includes a total resource quantity of to-be-collected resources, and the resource transfer information includes a resource transfer quantity.

After the receiving a resource collection request sent by a terminal device of a resource collection user, the following operations are further performed: generating resource collection record information of the resource collection user according to the resource collection information, and generating an identifier of the resource collection record information; and correspondingly writing the resource collection record information, the identifier of the resource collection record information, a user identifier of the resource collection user, and an institution identifier of a resource transaction institution to the blockchain.

The generating resource transfer record information according to the resource transfer request includes associatively records information including the resource transfer quantity, a user identifier of the resource transfer user, and an identifier of resource collection record information of the target resource collection user if it is determined that a total quantity of a quantity of current collected resources and the resource transfer quantity is not greater than the total resource quantity of the to-be-collected resources, and uses the recorded information as resource transfer record information of the resource transfer performed by the resource transfer user to the target resource collection user.

In an embodiment, when the computer executable instructions are executed, the resource collection information includes a resource grant time, and when it is determined that the sum of the quantity of the current collected resources and the resource transfer quantity is equal to the total resource quantity of the to-be-collected resources, after the generating resource transfer record information according to the resource transfer request, the following operations are further performed: providing, if determining that the resource grant time arrives, resources corresponding to the resource transfer quantity as collected resources, the current collected resources to the target resource collection user; generating resource grant record information; and writing the resource grant record information to the blockchain, wherein the resource grant record information includes the identifier of the resource collection record information of the target resource collection user.

In an embodiment, when the computer executable instructions are executed, after the receiving a resource transfer request sent by the terminal device of the resource transfer user, the following operations are further performed generating resource status record information according to a state of the to-be-collected resources, and writing the resource status record information to the blockchain, wherein the resource status record information includes status information representing the state of the to-be-collected resources and the identifier of the resource collection record information of the target resource collection user.

In an embodiment, when the computer executable instructions are executed, the following operations are further performed: receiving a resource extraction request sent by the terminal device of the resource transfer user; extracting a resource of the resource transfer user according to the resource extraction request; and generating resource extraction record information, and writing the resource extraction record information to the blockchain, wherein the resource extraction record information includes a resource extraction time, a user identifier of the resource transfer user, and an institution identifier of a resource transaction institution.

In an embodiment, when the computer executable instructions are executed, the following operations are further performed: generating, when a user of the resource transaction institution releases bulletin information of an operating status of the resource transaction institution on a website or an APP of the resource transaction institution using a terminal device of the user, bulletin release record information according to the bulletin information, and writing the bulletin release record information to the blockchain, wherein the bulletin release record information includes key information of the bulletin information and the institution identifier of the resource transaction institution; and generating, when the user of the resource transaction institution revokes the bulletin information using the terminal device of the user, bulletin revocation record information according to the revoked bulletin information, and writes the bulletin revocation record information to the blockchain, wherein the bulletin revocation record information includes a revocation time at which the bulletin information is revoked and the institution identifier of the resource transaction institution.

In an embodiment, when the computer executable instructions are executed, before the receiving a resource transfer request sent by the terminal device of the resource transfer user, the following operations are further performed: receiving a first registration request sent by the terminal device of the resource transfer user, wherein the first registration request includes first registration information; and determining the user identifier of the resource transfer user if determining that the first registration information is valid, generating first registration record information according to the first registration information, the user identifier of the resource transfer user, and the institution identifier of the resource transaction institution, and writing the first registration record information to the blockchain.

The blockchain-based transaction device provided in the one or more embodiments of the specification releases resource collection information to a blockchain by invoking or otherwise using a first blockchain contract when receiving a resource collection request sent by a terminal device of a resource collection user, for a terminal device of a resource transfer user to obtain the resource collection information from the blockchain, wherein the resource collection request includes the resource collection information; and when receiving a resource transfer request sent by a terminal device of a resource transfer user, generates, according to the resource transfer request, resource transfer record information of resource transfer performed by the resource transfer user to a target resource collection user, and writes the resource transfer record information to the blockchain. In one or more embodiments of the specification, a transaction is performed in a reliable environment of the blockchain, so that a transaction process is public and transparent and is available to a plurality of parties, which achieves a deterrent effect to illegal and other behavior. In addition, transaction record information such as the resource transfer record information is stored in the blockchain, so that it is ensured that chained data is tamperproof and publicly available, problems such as data loss and data fraud are effectively avoided, problems such as difficulties in testifying and defending rights of the resource transfer user are resolved, and an effective data basis is provided for transaction supervision.

Since the embodiments of the blockchain-based transaction device in the specification and the embodiments of the blockchain-based transaction method in the specification are based on the same idea, for specific implementation of the embodiments, reference may be made to the foregoing implementation of the blockchain-based transaction method, and details are not described again.

Further, corresponding to the method shown in FIG. 7, based on the same technical idea, one or more embodiments of the specification further provide a blockchain-based transaction supervision device. The device is configured to perform the blockchain-based transaction supervision method. FIG. 11 is a schematic structural diagram of the blockchain-based transaction supervision device, according to the embodiments of the specification.

As shown in FIG. 11, the blockchain-based transaction supervision device may vary greatly with different configurations or performance, and may include one or more processors 701 and memories 702. The memory 702 may store one or more application programs or data. The memory 702 may be a transient or persistent storage. The application program stored in the memory 702 may include one or more modules (not shown). Each module may include a series of computer executable instructions in the blockchain-based transaction supervision device. Furthermore, the processor 701 may be configured to communicate with the memory 702, and execute, on the blockchain-based transaction supervision device, a series of computer executable instructions in the memory 702. The blockchain-based transaction supervision device may further include one or more power supplies 703, one or more wired or wireless network interfaces 704, one or more input/output interfaces 705, one or more keyboards 706, and the like.

In an embodiment, the blockchain-based transaction supervision device includes a memory and one or more programs. The one or more programs are stored in the memory, the one or more programs may include one or more modules, each module may include a series of computer executable instructions in the blockchain-based transaction supervision device, and one or more processors are configured to execute the one or more programs including the following computer executable instructions to: obtain transaction record information of a resource transaction institution from a blockchain, wherein the transaction record information includes at least one piece of information among resource collection record information, resource status record information, resource transfer record information, resource extraction record information, first registration record information, bulletin release record information, and bulletin revocation record information; determine, based on the transaction record information by invoking or otherwise using a second blockchain contract, whether the resource transaction institution has a transaction risk; and send alert information to a tracing institution invoking or otherwise using the second blockchain contract if the resource transaction institution has a transaction risk, for the tracing institution to perform tracing processing on the resource transaction institution.

In the one or more embodiments of the specification, a transaction risk of a resource transaction institution can be found based on transaction record information in a blockchain as soon as possible, to timely perform tracing processing on the resource transaction institution, so that a transaction performed by the resource transaction institution is effectively supervised, and the occurrence that the resource transaction institution evades the responsibility or escapes is effectively reduced. In addition, a resource transfer user is not required to provide much proof in a supervision process, costs of defending rights of the resource transfer user are reduced, and supervision efficiency is improved.

In an embodiment, the resource collection record information includes a resource grant time, the resource extraction record information includes a resource extraction time and a user identifier of a resource transfer user, and the bulletin revocation record information includes a revocation time at which bulletin information is revoked.

When the computer executable instructions are executed, the determining, based on the transaction record information by invoking or otherwise using a second blockchain contract, whether the resource transaction institution has a transaction risk includes invoking the second blockchain contract, and performing at least one of the following operations based on the second blockchain contract: determining that the resource transaction institution has a transaction risk if determining, according to the resource collection record information and the resource status record information, that there is a transaction with a resource grant time earlier than a current time and a resource in a collected state but not granted state, and a resource quantity of collected resources exceeds a preset quantity; calculating, according to the first registration record information and the resource extraction record information, a first proportion of resource transfer users performing a resource extraction operation within a first preset time period in all resource transfer users registered with the resource transaction institution; and determining that the resource transaction institution has a transaction risk if the calculated first proportion exceeds a first preset proportion; determining, according to the bulletin release record information, whether the bulletin information released by the resource transaction institution meets a preset condition, and determining that the resource transaction institution has a transaction risk if the bulletin information meets the preset condition; or calculating, according to the bulletin release record information and the bulletin revocation record information, a second proportion of bulletin information revoked within a second preset time period in all bulletin information released by the resource transaction institution, and determining that the resource transaction institution has a transaction risk if the calculated second proportion exceeds a second preset proportion.

In an embodiment, when the computer executable instructions are executed, the following operations are further performed: counting, using a statistical task included in the second blockchain contract or a third blockchain contract, an operation quantity of operations performed within preset period on a complaint module included on a website or an APP of the resource transaction institution, and determining that the resource transaction institution has a transaction risk if the counted operation quantity is greater than a preset quantity; and sending alert information to the tracing institution using the second blockchain contract or the third blockchain contract.

The blockchain-based transaction supervision device provided in the one or more embodiments of the specification can obtain transaction record information of a resource transaction institution from a blockchain, wherein the transaction record information includes at least one piece of information among resource collection record information, resource status record information, resource transfer record information, resource extraction record information, first registration record information, bulletin release record information, and bulletin revocation record information; determine, based on the transaction record information by invoking or otherwise using a second blockchain contract, whether the resource transaction institution has a transaction risk; and send alert information to a tracing institution invoking or otherwise using the second blockchain contract if the resource transaction institution has a transaction risk, for the tracing institution to perform tracing processing on the resource transaction institution. In one or more embodiments of the specification, the transaction risk of the resource transaction institution can be found based on the transaction record information in the blockchain as soon as possible, to timely perform tracing processing on the resource transaction institution, so that a transaction performed by the resource transaction institution is effectively supervised, and the occurrence that the resource transaction institution evades the responsibility or escapes is effectively reduced. In addition, a resource transfer user is not required to provide much proof in a supervision process, costs of defending rights of the resource transfer user are reduced, and supervision efficiency is improved.

Since the embodiments of the blockchain-based transaction supervision device in the specification and the embodiments of the blockchain-based transaction supervision method in the specification are based on the same idea, for specific implementation of the embodiments, reference may be made to the foregoing implementation of the blockchain-based transaction supervision method, and details are not described again.

Further, corresponding to the method shown in FIG. 2 to FIG. 5, based on the same technical idea, one or more embodiments of the specification further provide a storage medium, configured to store computer executable instructions. In an embodiment, the storage medium may be a USB flash drive, an optical disc, a hard disk, or the like. The computer executable instructions stored in the storage medium, when executed by a processor, can implement the following process: receiving a resource collection request sent by a terminal device of a resource collection user, wherein the resource collection request includes resource collection information; releasing the resource collection information to a blockchain by invoking or otherwise using a first blockchain contract, for a terminal device of a resource transfer user to obtain the resource collection information from the blockchain; receiving a resource transfer request sent by the terminal device of the resource transfer user, wherein the resource transfer request includes: user information of a target resource collection user that is selected based on the resource collection information to perform resource transfer to, and resource transfer information of the resource transfer performed to the target resource collection user; and generating resource transfer record information according to the resource transfer request, and writing the resource transfer record information to the blockchain.

In the one or more embodiments of the specification, a transaction is performed in a reliable environment of a blockchain, so that a transaction process is public and transparent and is available to a plurality of parties, which achieves a deterrent effect to illegal and other behaviors. In addition, transaction transfer record information is written to the blockchain, so that it is ensured that chained data is tamperproof and publicly available, problems such as data loss and data fraud are effectively avoided, and problems such as difficulties in testifying and defending rights of a resource transfer user are resolved.

In an embodiment, when the computer executable instructions stored in the storage medium are executed by the processor, the resource collection information includes a total resource quantity of to-be-collected resources, and the resource transfer information includes a resource transfer quantity.

After the receiving a resource collection request sent by a terminal device of a resource collection user, the following operations are further performed: generating resource collection record information of the resource collection user according to the resource collection information, and generating an identifier of the resource collection record information; and correspondingly writing the resource collection record information, the identifier of the resource collection record information, a user identifier of the resource collection user, and an institution identifier of a resource transaction institution to the blockchain.

The generating resource transfer record information according to the resource transfer request includes: associatively records the resource transfer quantity, a user identifier of the resource transfer user, and an identifier of resource collection record information of the target resource collection user if it is determined that a total quantity of a quantity of current collected resources and the resource transfer quantity is not greater than the total resource quantity of the to-be-collected resources, and uses the recorded information as resource transfer record information of the resource transfer performed by the resource transfer user to the target resource collection user.

In an embodiment, when the computer executable instructions stored in the storage medium are executed by the processor, the resource collection information includes a resource grant time, and when it is determined that the sum of the quantity of the current collected resources and the resource transfer quantity is equal to the total resource quantity of the to-be-collected resources, after the generating resource transfer record information according to the resource transfer request, the following operations are further performed: using, if determining that the resource grant time arrives, resources corresponding to the resource transfer quantity as collected resources, providing the current collected resources to the target resource collection user, generating resource grant record information, and writing the resource grant record information to the blockchain, wherein the resource grant record information includes the identifier of the resource collection record information of the target resource collection user.

In an embodiment, when the computer executable instructions stored in the storage medium are executed by the processor, after the receiving a resource transfer request sent by the terminal device of the resource transfer user, the following operations are further performed: generating resource status record information according to a state of the to-be-collected resources, and writing the resource status record information to the blockchain, wherein the resource status record information includes status information representing the state of the to-be-collected resources and the identifier of the resource collection record information of the target resource collection user.

In an embodiment, when the computer executable instructions stored in the storage medium are executed by the processor, the following operations are further performed: receiving a resource extraction request sent by the terminal device of the resource transfer user; extracting a resource of the resource transfer user according to the resource extraction request; and generating resource extraction record information, and writing the resource extraction record information to the blockchain, wherein the resource extraction record information includes: a resource extraction time, a user identifier of the resource transfer user, and an institution identifier of a resource transaction institution.

In an embodiment, when the computer executable instructions stored in the storage medium are executed by the processor, the following operations are further performed: generating, when a user of the resource transaction institution releases bulletin information of an operating status of the resource transaction institution on a website or an APP of the resource transaction institution using a terminal device of the user, bulletin release record information according to the bulletin information, and writing the bulletin release record information to the blockchain, wherein the bulletin release record information includes key information of the bulletin information and the institution identifier of the resource transaction institution; and generating, when the user of the resource transaction institution revokes the bulletin information using the terminal device of the user, bulletin revocation record information according to the revoked bulletin information, and writing the bulletin revocation record information to the blockchain, wherein the bulletin revocation record information includes a revocation time at which the bulletin information is revoked and the institution identifier of the resource transaction institution.

In an embodiment, when the computer executable instructions stored in the storage medium are executed by the processor, before the receiving a resource transfer request sent by the terminal device of the resource transfer user, the following operations are further performed: receiving a first registration request sent by the terminal device of the resource transfer user, wherein the first registration request includes first registration information; and determining the user identifier of the resource transfer user if determining that the first registration information is valid, generating first registration record information according to the first registration information, the user identifier of the resource transfer user, and the institution identifier of the resource transaction institution, and writing the first registration record information to the blockchain.

When the computer executable instructions stored in the storage medium provided in the one or more embodiments of the specification are executed by the processor, a resource collection request sent by a terminal device of a resource collection user is received, wherein the resource collection request includes resource collection information, and the resource collection information is released to a blockchain by invoking or otherwise using a first blockchain contract, for a terminal device of a resource transfer user to obtain the resource collection information from the blockchain; and when a resource transfer request sent by the terminal device of the resource transfer user is received, resource transfer record information of resource transfer performed by the resource transfer user to a target resource collection user is generated according to the resource transfer request, and the resource transfer record information is written to the blockchain. In one or more embodiments of the specification, a transaction is performed in a reliable environment of the blockchain, so that a transaction process is public and transparent and is available to a plurality of parties, which achieves a deterrent effect to illegal and other behavior. In addition, transaction record information such as the resource transfer record information is stored in the blockchain, so that it is ensured that chained data is tamperproof and publicly available, problems such as data loss and data fraud are effectively avoided, problems such as difficulties in testifying and defending rights of the resource transfer user are resolved, and an effective data basis is provided for transaction supervision.

Since the embodiments of the storage medium in the specification and the embodiments of the blockchain-based transaction method in the specification are based on the same idea, for specific implementation of the embodiments, reference may be made to the foregoing implementation of the blockchain-based transaction method, and details are not described again.

Further, corresponding to the method shown in FIG. 7, based on the same technical idea, one or more embodiments of the specification further provide a storage medium, configured to store computer executable instructions. In an embodiment, the storage medium may be a USB flash drive, an optical disc, a hard disk, or the like. The computer executable instructions stored in the storage medium, when executed by a processor, can implement the following process: obtaining transaction record information of a resource transaction institution from a blockchain, wherein the transaction record information includes at least one piece of information among resource collection record information, resource status record information, resource transfer record information, resource extraction record information, first registration record information, bulletin release record information, and bulletin revocation record information; determining, based on the transaction record information by invoking or otherwise using a second blockchain contract, whether the resource transaction institution has a transaction risk; and sending alert information to a tracing institution invoking or otherwise using the second blockchain contract if the resource transaction institution has a transaction risk, for the tracing institution to perform tracing processing on the resource transaction institution.

In the one or more embodiments of the specification, a transaction risk of a resource transaction institution can be found based on transaction record information in a blockchain as soon as possible, to timely perform tracing processing on the resource transaction institution, so that a transaction performed by the resource transaction institution is effectively supervised, and the occurrence that the resource transaction institution evades the responsibility or escapes is effectively reduced. In addition, a resource transfer user is not required to provide much proof in a supervision process, costs of defending rights of the resource transfer user are reduced, and supervision efficiency is improved.

In an embodiment, when the computer executable instructions stored in the storage medium are executed by the processor, the resource collection record information includes a resource grant time, the resource extraction record information includes a resource extraction time and a user identifier of a resource transfer user, and the bulletin revocation record information includes a revocation time at which bulletin information is revoked.

The determining, based on the transaction record information by invoking or otherwise using a second blockchain contract, whether the resource transaction institution has a transaction risk includes invoking the second blockchain contract, and performing at least one of the following operations based on the second blockchain contract: determining that the resource transaction institution has a transaction risk if determining, according to the resource collection record information and the resource status record information, that there is a transaction with a resource grant time earlier than a current time and a resource in a collected but not granted state, and a resource quantity of collected resources exceeds a preset quantity; calculating, according to the first registration record information and the resource extraction record information, a first proportion of resource transfer users performing a resource extraction operation within a first preset time period in all resource transfer users registered with the resource transaction institution; and determining that the resource transaction institution has a transaction risk if the calculated first proportion exceeds a first preset proportion; determining, according to the bulletin release record information, whether the bulletin information released by the resource transaction institution meets a preset condition, and determining that the resource transaction institution has a transaction risk if the bulletin information meets the preset condition; and calculating, according to the bulletin release record information and the bulletin revocation record information, a second proportion of bulletin information revoked within a second preset time period in all bulletin information released by the resource transaction institution, and determining that the resource transaction institution has a transaction risk if the calculated second proportion exceeds a second preset proportion.

In an embodiment, when the computer executable instructions stored in the storage medium are executed by the processor, the following operations are further performed: counting, using a statistical task included in the second blockchain contract or a third blockchain contract, an operation quantity of operations performed within preset period on a complaint module included on a website or an APP of the resource transaction institution, and determining that the resource transaction institution has a transaction risk if the counted operation quantity is greater than a preset quantity; and sending alert information to the tracing institution using the second blockchain contract or the third blockchain contract.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

When the functions disclosed herein are implemented in the form of software functional units and sold or used as independent products, they can be stored in a processor executable non-volatile computer readable storage medium. Particular technical solutions disclosed herein (in whole or in part) or aspects that contributes to current technologies may be embodied in the form of a software product. The software product may be stored in a storage medium, comprising a number of instructions to cause a computing device (which may be a personal computer, a server, a network device, and the like) to execute all or some steps of the methods of the embodiments. The storage medium may comprise a flash drive, a portable hard drive, ROM, RAM, a magnetic disk, an optical disc, another medium operable to store program code, or any combination thereof.

When the computer executable instructions stored in the storage medium provided in the one or more embodiments of the specification are executed by the processor, transaction record information of a resource transaction institution is obtained from a blockchain, wherein the transaction record information includes at least one piece of information among resource collection record information, resource status record information, resource transfer record information, resource extraction record information, first registration record information, bulletin release record information, and bulletin revocation record information; whether the resource transaction institution has a transaction risk is determined based on the transaction record information by invoking or otherwise using a second blockchain contract; and alert information is sent to a tracing institution invoking or otherwise using the second blockchain contract if the resource transaction institution has a transaction risk, for the tracing institution to perform tracing processing on the resource transaction institution. In one or more embodiments of the specification, the transaction risk of the resource transaction institution can be found based on the transaction record information in the blockchain as soon as possible, to timely perform tracing processing on the resource transaction institution, so that a transaction performed by the resource transaction institution is effectively supervised, and the occurrence that the resource transaction institution evades the responsibility or escapes is effectively reduced. In addition, a resource transfer user is not required to provide much proof in a supervision process, costs of defending rights of the resource transfer user are reduced, and supervision efficiency is improved.

Since the embodiments of the storage medium in the specification and the embodiments of the blockchain-based transaction supervision method in the specification are based on the same idea, for specific implementation of the embodiments, reference may be made to the foregoing implementation of the blockchain-based transaction supervision method, and details are not described again.

In the 1990s, improvements of a technology can be clearly distinguished between hardware improvements (for example, improvements to a circuit structure such as a diode, a transistor, a switch, etc.) and software improvements (improvements to a method procedure). However, with the development of technology, improvements of many method procedures can be considered as direct improvements of hardware circuit structures. Designers almost all program an improved method procedure to a hardware circuit, to obtain a corresponding hardware circuit structure. Therefore, it does not mean that the improvement of a method procedure cannot be implemented using a hardware entity module. For example, a programmable logic device (PLD) such as a field programmable gate array (FPGA) is a type of integrated circuit whose logic function is determined by a user by programming the device. The designers perform voluntary programming to “integrate” a digital system into a single PLD without requiring a chip manufacturer to design and prepare a dedicated integrated circuit chip. Moreover, nowadays, instead of manually making integrated circuit chips, this programming is mostly implemented using “logic compiler” software, which is similar to the software compiler used in program development and writing. The original code is written in a specific programming language before compiling, and this language is referred to as a hardware description language (HDL). There are various kinds of HDLs, for example, advanced boolean expression language (ABEL), altera hardware description language (AHDL), Confluence, cornell university programming language (CUPL), HDCal, Java hardware description language (JHDL), Lava, Lola, MyHDL, PALASM, Ruby hardware description language (RHDL), and the like. Currently, the most commonly used HDLs are very-high-speed integrated circuit hardware description language (VHDL) and Verilog. A person skilled in the art should also understand that as long as a method procedure is logically programmed and then programmed to an integrated circuit using the foregoing hardware description languages, a hardware circuit that implements the logical method procedure can be easily obtained.

The controller can be implemented in any suitable manner, for example, the controller can take the form of, for example, a microprocessor or processor and a computer-readable medium storing computer-readable program code (for example, software or firmware) executable by the processor, a logic gate, a switch, an application-specific integrated circuit (ASIC), a programmable logic controller and an embedded microcontroller. Examples of the controller include, but are not limited to, the following microcontrollers: ARC 625D, Atmel AT91SAM, Microchip PIC18F26K20 and Silicone Labs C8051F320. The memory controller can also be implemented as part of the memory control logic. A person skilled in the art will also appreciate that, in addition to implementing the controller in the form of pure computer-readable program code, it is also possible to implement the controller in the form of a logic gate, switch, application-specific integrated circuit, programmable logic controller, and embedded microcontroller and other forms to achieve the same function. Such a controller can thus be considered as a hardware component and apparatuses included therein for implementing various functions can also be considered as structures inside the hardware component. Alternatively, apparatuses configured to implement various functions can be considered as both software modules implementing the method and structures inside the hardware component.

The system, the apparatus, the module or the unit described in the foregoing embodiments can be specifically implemented by a computer chip or an entity or implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, when the apparatus is described, the apparatus is divided into units according to functions, which are separately described. Certainly, in implementation of the specification, the function of the units may be implemented in a same piece of or multiple pieces of software and/or hardware.

A person skilled in the art should understand that the embodiments of the specification may be provided as a method, a system, or a computer program product. Therefore, the specification may use a form of a hardware-only embodiment, a software-only embodiment, or an embodiment combining software and hardware. In addition, the specification may use a form of a computer program product implemented on one or more computer available storage media (including but not limited to a disk memory, a CD-ROM, an optical memory, and the like) including computer available program code.

The specification is described with reference to flowcharts and/or block diagrams of the method, the device (system), and the computer program product in the embodiments of the specification. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated using instructions executed by the general-purpose computer or the processor of another programmable data processing device.

These computer program instructions may also be stored in a computer readable memory that can guide a computer or another programmable data processing device to work in a specific manner, so that the instructions stored in the computer readable memory generate a product including an instruction apparatus, wherein the instruction apparatus implements functions specified in one or more procedures in the flowcharts and/or one or more blocks in the block diagrams.

These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more procedures in the flowcharts and/or one or more blocks in the block diagrams.

In a typical configuration, the computer device includes one or more processors (CPUs), an input/output interface, a network interface, and a memory.

The memory may include, among computer readable media, a non-persistent memory such as a random access memory (RAM) and/or a non-volatile memory such as a read-only memory (ROM) or a flash memory (flash RAM). The memory is an example of the computer readable medium.

The computer readable medium includes a persistent medium and a non-persistent medium, a removable medium and a non-removable medium, which may implement storage of information using any method or technology. The information may be a computer readable instruction, a data structure, a module of a program or other data. Examples of computer storage media include but are not limited to a phase change memory (PRAM), a static random access memory (SRAM), a dynamic random access memory (DRAM), other type of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a cassette magnetic tape, tape and disk storage or other magnetic storage device or any other non-transmission media that may be configured to store information that a computing device can access. Based on the definition herein, the computer-readable medium does not include transitory computer readable media (transitory media), such as a modulated data signal and a carrier.

It should also be noted that the terms “include,” “comprise” and any other variants mean to cover the non-exclusive inclusion. Thereby, the process, method, article, or device which include a series of elements not only include those elements, but also include other elements which are not clearly listed, or include the inherent elements of the process, method, article and device. Without further limitation, the element defined by a phrase “include one” does not exclude other same elements in the process, method, article or device which include the element.

A person skilled in the art should understand that the embodiments of the specification may be provided as a method, a system, or a computer program product. Therefore, the specification may use a form of hardware only embodiments, software only embodiments, or embodiments with a combination of software and hardware. In addition, the specification may use a form of a computer program product implemented on one or more computer available storage media (including but not limited to a disk memory, a CD-ROM, an optical memory, and the like) including computer available program code.

The specification can be described in the general context of computer executable instructions executed by a computer, for example, a program module. Generally, the program module includes a routine, a program, an object, a component, a data structure, and the like for executing a particular task or implementing a particular abstract data type. The specification can also be practiced in a distributed computing environment in which tasks are performed by remote processing devices that are connected through a communication network. In a distributed computing environment, the program module may be located in both local and remote computer storage media including storage devices.

The embodiments of the specification are all described in a progressive manner, for same or similar parts in the embodiments, refer to these embodiments, and descriptions of each embodiment focus on a difference from other embodiments. Especially, a system embodiment is basically similar to a method embodiment, and therefore is described briefly; for related parts, reference may be made to partial descriptions in the method embodiment.

The foregoing descriptions are merely embodiments of the specification and are not intended to limit the specification. For a person skilled in the art, various modifications and variations can be made to the specification. Any modification, equivalent replacement, or improvement made without departing from the spirit and principle of the specification shall fall within the scope of the claims of the specification.

1. A blockchain-based method, comprising:
receiving, by a blockchain node associated with a blockchain from a terminal device of a first user, a resource collection request;
generating, by the blockchain node, a resource collection record and an identifier of the resource collection record based on the resource collection request;
recording, by the blockchain node to the blockchain, the identifier of the resource collection record and an identifier of the first user in correspondence with the resource collection record;
releasing, by the blockchain node to the blockchain, information associated with the resource collection request by invoking a first blockchain contract;
receiving, by the blockchain node from a terminal device of a second user, a resource transfer request comprising the identifier of the first user and a resource transfer quantity, the resource transfer request being generated in response to the terminal device of the second user obtaining the information associated with the resource collection request from the blockchain;
generating, by the blockchain node, a resource transfer record according to the resource transfer request, the resource transfer record comprising the resource transfer quantity, the identifier of the first user, the identifier of the resource collection record; and
recording, by the blockchain node to the blockchain, the resource transfer record.

2. The method of claim 1, wherein:
the resource collection request comprises a total resource quantity to be collected; and
the generating a resource transfer record comprises determining that a sum of a quantity of currently collected resources and the resource transfer quantity is not greater than the total resource quantity to be collected.

3. The method of claim 1, wherein:
the resource collection request comprises a resource grant time; and
the method further comprises:
providing, by the blockchain node, the resource transfer quantity of a resource to the first user when the resource grant time arrives;
generating, by the blockchain node, a resource grant record comprising the identifier of the resource collection record information; and
recording, by the blockchain node to the blockchain, the resource grant record.

4. The method of claim 1, further comprising:
generating, by the blockchain node, a resource status record associated with resources to be collected in response to the resource collection request, wherein the resource status record comprises the identifier of the resource collection record.

5. The method of claim 1, further comprising:
receiving, by the blockchain node from the terminal device of the second user, a resource extraction request;
extracting, by the blockchain node, a resource of the second user according to the resource extraction request;
generating, by the blockchain node, a resource extraction record, wherein the resource extraction record comprises a resource extraction time, an identifier of the second user, and an institution identifier of a resource transaction institution; and
recording, by the blockchain node to the blockchain, the resource extraction record.

6. The method of claim 1, further comprising:
obtaining, by the blockchain node, bulletin information of an operating status of a resource transaction institution released by a user on a website or an application (APP) of the resource transaction institution on a terminal device of the user;
generating, by the blockchain node, a bulletin release record according to the bulletin information, wherein the bulletin release record comprises key information of the bulletin information and an identifier of the resource transaction institution; and
recording, by the blockchain node to the blockchain, the bulletin release record.

7. The method of claim 6, further comprising:
obtaining, by the blockchain node, a revocation of the bulletin information by the user on a website or an application (APP) of the resource transaction institution on a terminal device of the user;
generating, by the blockchain node, a bulletin revocation record according to the revoked bulletin information, wherein the bulletin revocation record comprises a revocation time at which the bulletin information is revoked and the institution identifier of the resource transaction institution; and
recording, by the blockchain node to the blockchain, the bulletin revocation record.

8. The method of claim 1, further comprising, before receiving the resource transfer request:
receiving, by the blockchain node from the terminal device of the second user, a registration request;
determining, by the blockchain node, whether information in the registration request is valid;
determining, by the blockchain node in response to determining that the information in the registration request is valid, an identifier of the second user;
generating, by the blockchain node, a registration record according to the information in the registration request, the identifier of the second user, an institution identifier of a resource transaction institution; and
recording, by the blockchain node to the blockchain, the registration record information.

9. A blockchain-based system, comprising a processor and a non-transitory computer-readable storage medium storing instructions executable by the processor to cause the system to perform operations comprising:
receiving, from a terminal device of a first user, a resource collection request;
generating a resource collection record and an identifier of the resource collection record based on the resource collection request;
recording, to a blockchain, the identifier of the resource collection record and an identifier of the first user in correspondence with the resource collection record;
releasing, to the blockchain, information associated with the resource collection request by invoking a first blockchain contract;
receiving, from a terminal device of a second user, a resource transfer request comprising the identifier of the first user and a resource transfer quantity, the resource transfer request being generated in response to the terminal device of the second user obtaining the information associated with the resource collection request from the blockchain;
generating a resource transfer record according to the resource transfer request, the resource transfer record comprising the resource transfer quantity, the identifier of the first user, the identifier of the resource collection record; and
recording, to the blockchain, the resource transfer record.

10. The system of claim 9, wherein:
the resource collection request comprises a total resource quantity to be collected; and
the generating a resource transfer record comprises determining that a sum of a quantity of currently collected resources and the resource transfer quantity is not greater than the total resource quantity to be collected.

11. The system of claim 9, wherein:
the resource collection request comprises a resource grant time; and
the operations further comprise:
providing the resource transfer quantity of a resource to the first user when the resource grant time arrives;
generating a resource grant record comprising the identifier of the resource collection record information; and
recording, to the blockchain, the resource grant record.

12. The system of claim 9, wherein the operations further comprise:
generating a resource status record associated with resources to be collected in response to the resource collection request, wherein the resource status record comprises the identifier of the resource collection record.

13. The system of claim 9, wherein the operations further comprise:
receiving, from the terminal device of the second user, a resource extraction request;
extracting a resource of the second user according to the resource extraction request;
generating a resource extraction record, wherein the resource extraction record comprises a resource extraction time, an identifier of the second user, and an institution identifier of a resource transaction institution; and
recording, to the blockchain, the resource extraction record.

14. The system of claim 9, wherein the operations further comprise:
obtaining bulletin information of an operating status of a resource transaction institution released by a user on a website or an application (APP) of the resource transaction institution on a terminal device of the user;
generating a bulletin release record according to the bulletin information, wherein the bulletin release record comprises key information of the bulletin information and an identifier of the resource transaction institution; and
recording, to the blockchain, the bulletin release record.

15. The system of claim 14, wherein the operations further comprise:
obtaining a revocation of the bulletin information by the user on a website or an application (APP) of the resource transaction institution on a terminal device of the user;
generating a bulletin revocation record according to the revoked bulletin information, wherein the bulletin revocation record comprises a revocation time at which the bulletin information is revoked and the institution identifier of the resource transaction institution; and
recording, to the blockchain, the bulletin revocation record.

16. The system of claim 9, wherein the operations further comprise, before receiving the resource transfer request:
receiving, from the terminal device of the second user, a registration request;
determining whether information in the registration request is valid;
determining, in response to determining that the information in the registration request is valid, an identifier of the second user;
generating a registration record according to the information in the registration request, the identifier of the second user, an institution identifier of a resource transaction institution; and
recording, to the blockchain, the registration record information.

17. A non-transitory computer-readable storage medium for a blockchain, configured with instructions executable by one or more processors to cause the one or more processors to perform operations comprising:
receiving, from a terminal device of a first user, a resource collection request;
generating a resource collection record and an identifier of the resource collection record based on the resource collection request;
recording, to a blockchain, the identifier of the resource collection record and an identifier of the first user in correspondence with the resource collection record;
releasing, to the blockchain, information associated with the resource collection request by invoking a first blockchain contract;
receiving, from a terminal device of a second user, a resource transfer request comprising the identifier of the first user and a resource transfer quantity, the resource transfer request being generated in response to the terminal device of the second user obtaining the information associated with the resource collection request from the blockchain;
generating a resource transfer record according to the resource transfer request, the resource transfer record comprising the resource transfer quantity, the identifier of the first user, the identifier of the resource collection record; and
recording, to the blockchain, the resource transfer record.

18. The medium of claim 17, wherein the operations further comprise:
receiving, from the terminal device of the second user, a resource extraction request;
extracting a resource of the second user according to the resource extraction request;
generating a resource extraction record, wherein the resource extraction record comprises a resource extraction time, an identifier of the second user, and an institution identifier of a resource transaction institution; and
recording, to the blockchain, the resource extraction record.

19. The medium of claim 17, wherein the operations further comprise:
obtaining bulletin information of an operating status of a resource transaction institution released by a user on a website or an application (APP) of the resource transaction institution on a terminal device of the user;
generating a bulletin release record according to the bulletin information, wherein the bulletin release record comprises key information of the bulletin information and an identifier of the resource transaction institution; and
recording, to the blockchain, the bulletin release record.

20. The system of claim 17, wherein the operations further comprise:
obtaining a revocation of the bulletin information by the user on a website or an application (APP) of the resource transaction institution on a terminal device of the user;
generating a bulletin revocation record according to the revoked bulletin information, wherein the bulletin revocation record comprises a revocation time at which the bulletin information is revoked and the institution identifier of the resource transaction institution; and
recording, to the blockchain, the bulletin revocation record.
